(19) United States
(12) Patent Application Publication
(10) Pub. No.: US 2023/0284314 A1
(43) Pub. Date: Sep. 7, 2023

(54) Managing Packet-Based Multimedia Network Connections During Master Cell Group Failure

(71) Applicant: GOOGLE LLC, Mountain View, CA (US)

(72) Inventor: Chih-Hsiang Wu, Taoyuan City (TW)

(21) Appl. No.: 18/013,241

(22) PCT Filed: Jun. 23, 2021
(86) PCT No.: PCT/US2021/038575

§ 371 Date: Dec. 27, 2022

Related U.S. Application Data
(60) Provisional application No. 63/044,311, filed on Jun. 25, 2020.

(51) Int. Cl. H04W 76/19; H04W 76/25

(52) U.S. Cl. CPC H04W 76/19; H04W 76/25

(57) ABSTRACT

A first node of a radio access network (RAN) can implement a method for managing a connection between a network entity that supports packet-based calls and a UE in dual connectivity with an MN and an SN. The method includes communicating (1502), by processing hardware, information between the network entity and the UE, using a first radio bearer associated with an MCG for the UE. In addition, the method includes determining (1504), by the processing hardware, that the UE has detected an MCG failure. Further, the method includes sending, by the processing hardware, to a second node of the RAN supporting a secondary cell group (SCG) for the UE, a request to configure a second radio bearer to maintain the connection between the UE and the network entity using the second radio bearer.

### TECHNICAL FIELD

This disclosure relates generally to wireless communications and, more particularly, to managing connections with a packet-based network during MCG failure while a user equipment (UE) is in dual connectivity (DC) with a master node (MN) and a secondary node (SN).

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A user device (or user equipment, commonly denoted by acronym “UE”) in some cases can concurrently utilize resources of multiple network nodes, e.g., base stations, interconnected by a backhaul. When these network nodes support the same radio access technology (RAT) or different RATs, this type of connectivity is referred to as Dual Connectivity (DC) or Multi-Radio DC (MR-DC), respectively. Typically, when a UE operates in DC or MR-DC, one base station operates as a master node (MN), and the other base station operates as a secondary node (SN). The backhaul can support an Xn interface, for example.

The MN can provide a control-plane connection and a user-plane connection to a core network (CN), whereas the SN generally provides only a user-plane connection. The cells associated with the MN define a master cell group (MCG), and the cells associated with the SN define a secondary cell group (SCG). The UE and the base stations MN and SN can use signaling radio bearers (SRBs) to exchange radio resource control (RRC) messages, as well as non-access stratum (NAS) messages.

There are several types of SRBs that a UE can use when operating in DC. SRB1 and SRB2 resources allow the UE and the MN to exchange RRC messages related to the MN and to embed RRC messages related to the SN, and can be referred to as MCG SRBs. SRB3 resources allow the UE and the SN to exchange RRC messages related to the SN, and can be referred to as an SCG SRB. Split SRBs allow the UE to exchange RRC messages directly with the MN by using radio resources of the MN, the SN, or both of the MN and SN. Further, the UE and the base stations (e.g., MN and SN) use data radio bearers (DRBs) to transport data on a user plane. The DRBs can be MN-terminated DRBs or SN-terminated DRBs. The MN terminated-DRBs using the lower-layer resources of only the MN can be referred as MCG DRBs, the SN-terminated DRBs using the lower-layer resources of only the SN can be referred as SCG DRBs, and the DRBs using the lower-layer resources of both the MN and the SN can be referred to as split DRBs.

To enhance DC operations, the 3GPP organization has proposed a so-called “fast MCG recovery procedure.” In accordance with this procedure, when a UE operating in DC detects MCG failure (e.g., a listen-before-talk failure or a radio link failure on the MCG), the UE suspends MCG transmissions for all radio bearers. The UE reports the MCG failure by transmitting an MCGFailureInformation message to the SN via the SCG using an SCG leg of a split SRB1 or an SRB3. If reporting via an SRB3, the UE generates a ULInformationTransferMRDC message including the MCGFailureInformation message and transmits the ULInformationTransferMRDC message to the SN.

The SN notifies the MN of the MCG failure by forwarding the MCGFailureInformation message to the MN within an RRC Transfer message. Upon receiving the MCGFailureInformation message from the SN, the MN can send an RRC reconfiguration message or an RRC release message to the UE using the SCG leg of a split SRB1 or an SRB3. Upon receiving an RRC reconfiguration message, the UE resumes MCG transmissions for all radio bearers. Upon receiving an RRC release message, the UE releases all the radio bearers and configurations.

In some cases, a UE operating in DC with an MN and an SN experiences an MCG failure while connected to a packet-based multimedia network, such as an IP Multimedia Subsystem (IMS) network, over an MCG bearer (i.e., a DRB that only uses MCG radio resources or an MCG Radio Link Control (RLC) bearer provided by the MN).

For example, prior to detecting the MCG failure, the UE may have an IMS signaling connection on an MCG bearer. The UE can utilize the IMS signaling connection to, for example, initiate a mobile originating (MO) voice call, receive a mobile terminating (MT) voice call, send and receive short messages, or send and receive video. During the MCG failure (i.e., before the MCG failure is recovered), the UE cannot transmit IMS signaling messages (e.g., Session Initiation Protocol (SIP) messages) over the MCG bearer, and the MN cannot transmit IMS signaling messages to the UE. As a result, the UE cannot initiate an IMS service during the MCG failure.

As another example, in addition to an IMS signaling connection on a first MCG bearer, the UE may have a packet-based call (e.g., an IMS service such as a voice or video call) on a second MCG bearer. If the UE experiences an MCG failure during the packet-based call, the packet-based call may be interrupted because the UE and the MN cannot exchange media packets (e.g., voice or video packets) during the MCG failure. During a voice call, for instance, the UE may stop receiving new voice packets and fail to play audio due to the MCG failure.

### SUMMARY

Generally speaking, the techniques of this disclosure enable a user equipment (UE) to maintain a connection with a packet-based network during a master cell group (MCG) failure.

More particularly, a radio access network (RAN) of this disclosure communicates with a UE in dual connectivity with a master node (MN) and a secondary node (SN). The UE has a connection with a network entity (e.g., an IMS server) that supports packet-based calls via the RAN. Initially, a first node of the RAN communicates information between the network entity and the UE using a radio bearer with a first link associated with a master cell group (MCG) of the UE. The first link may be an MCG radio bearer or an MCG link of a split bearer. Further, the first node may be the MN or a central unit (CU) of a distributed base station that operates as both the MN and the SN.

The first node then determines that the UE has detected an MCG failure on the first link. The first node causes the UE to maintain the connection with the network entity using a second link between the UE and a second node of the RAN. In some scenarios, causing the UE to maintain the connection may include sending a request to an SN, or a distributed unit (DU) of an SN, to configure an SCG bearer to replace the first link. In scenarios where the first link is an MCG link of a split bearer, causing the UE to maintain the connection may include causing the UE to use an SCG link of the split bearer. In such scenarios, the first node may configure the UE to use the SCG link of the split bearer prior to detecting the MCG failure. In yet further scenarios, causing the UE to maintain the connection with the network entity may include causing the UE to hand over to the second node, which may be the SN, a distributed unit of the SN, or a target base station.

An example embodiment of the techniques of this disclosure is a method, in a first node of a RAN, for managing a connection between a network entity that supports packet-based calls and a UE in dual connectivity with an MN and an SN. The method includes communicating, by processing hardware, information between the network entity and the UE, using a radio bearer with a first link associated with an MCG of the UE. In addition, the method includes determining, by the processing hardware, that the UE has detected an MCG failure on the first link. Further, the method includes causing, by the processing hardware, the UE to maintain the connection with the network entity using a second link between the UE and a second node of the RAN.

Another example embodiment of these techniques is a node of a RAN including processing hardware and configured to implement the method above.

Yet another example embodiment of these techniques is a method in a UE in dual connectivity with an MN and an SN of a RAN for managing a connection with a network entity that supports packet-based calls via the RAN. The method includes communicating, by processing hardware, information with the network entity using a radio bearer with a first link between the UE and a first node of the RAN, the first link associated with an MCG of the UE. The method also includes detecting, by the processing hardware, an MCG failure on the first link. Further, the method includes maintaining, by the processing hardware, the connection with the network entity using a second link between the UE and a second node of the RAN.

A further example embodiment of these techniques is a UE including processing hardware and configured to implement the method above.

### BRIEF DESCRIPTION OF THE DRAWINGS

FIG. 1A is a block diagram of an example system in which a radio access network (RAN) and a user equipment (UE) can implement the techniques of this disclosure for managing connections during an MCG failure between the UE and a network entity that supports packet-based calls;

FIG. 1B is a block diagram of an example base station including a central unit (CU) and at least one distributed unit (DU) that can operate in the system of FIG. 1A;

FIG. 2 is a block diagram of an example protocol stack according to which the UE of FIG. 1 communicates with base stations;

FIG. 3A is a messaging diagram of an example scenario in which a UE having an IMS signaling connection and an IMS service over MCG bearers notifies a master node (MN) of an MCG failure and, in response, the MN configures SCG bearers for the UE to enable the UE to maintain the IMS signaling connection and IMS service over the SCG bearers;

FIG. 3B is a messaging diagram of an example scenario in which a UE having an IMS signaling connection over an MCG bearer notifies the MN of an MCG failure and, in response, the MN configures an SCG bearer for the UE to enable the UE to maintain the IMS signaling connection over the SCG bearer;

FIG. 3C is a messaging diagram of an example scenario in which a UE having an IMS signaling connection and an IMS service over split bearers detects an MCG failure and, in response, continues the IMS signaling connection and the IMS service over SCG links of the split bearers;

FIG. 3D is a messaging diagram of an example scenario in which a UE having an IMS signaling connection over a split bearer detects an MCG failure and, in response, continues the IMS signaling connection over an SCG link of the split bearer;

FIGS. 4A-4D are messaging diagrams of example scenarios similar to 3A-3D, respectively, but where portions of the same base station serve as the MN and the SN;

FIG. 5 is a messaging diagram of an example scenario in which a UE having an IMS signaling connection over an MCG bearer or split bearer notifies the MN of an MCG failure and, in response, the MN determines to hand over the UE to the SN;

FIG. 6 is a messaging diagram of an example scenario similar to FIG. 5, but where portions of the same base station serve as the MN and the SN;

FIG. 7 is a messaging diagram of an example scenario similar to FIG. 5, but where the MN determines to hand over the UE to a target base station (T-BS);

FIG. 8A is a messaging diagram of an example scenario in which the MN determines whether to enable an MCG fast recovery function for the UE based on whether the UE has a packet-based call, and the UE determines how to respond to an MCG failure based on whether an MCG fast recovery function is enabled for the UE;

FIG. 8B is a messaging diagram of an example scenario in which the MN selects a longer or shorter timer value for the MCG fast recovery function based on whether the UE has a packet-based call;

FIG. 9A is a messaging diagram of an example scenario in which the UE determines how to respond to an MCG failure based on whether the UE has a packet-based call;

FIG. 9B is a messaging diagram of an example scenario in which the UE determines how to respond to an MCG failure based on the length of the recovery timer for the MCG fast recovery function;

FIG. 10A is a flow diagram of an example method for configuring an SCG bearer in response to determining that an MCG failure has occurred for a UE, which can be implemented in an MN;

FIG. 10B is a flow diagram of an example method for configuring an SCG bearer or a split bearer for an IMS connection in response to determining that an MCG failure has occurred for a UE, which can be implemented in an MN;

FIG. 10C is a flow diagram of an example method for initiating a handover of a UE to a T-BS in response to determining that an MCG failure has occurred for a UE, which can be implemented in an MN;

FIG. 10D is a flow diagram of an example method for configuring a new link for an IMS connection for a UE in response to determining that an MCG failure has occurred for the UE, which can be implemented in an MN;

FIG. 11A is a flow diagram of an example method for configuring an SCG bearer or a split bearer for an IMS connection for a UE in response to receiving a RAN-CN interface message, which can be implemented in an MN;

FIG. 11B is a flow diagram of an example method for initiating a handover to a T-BS or redirecting a UE to a target cell or target carrier frequency for an IMS connection for a UE in response to receiving a RAN-CN interface message, which can be implemented in an MN;

FIG. 11C is a flow diagram of an example method for configuring an MCG bearer for an IMS connection for a UE after recovering an MCG failure, which can be implemented in an MN;

FIG. 11D is a flow diagram of an example method for configuring a new link for an IMS connection for a UE in response to receiving a RAN-CN interface message, which can be implemented in an MN;

FIG. 12 is a flow diagram of an example method for configuring a split bearer or an MCG bearer for an IMS connection for a UE in response to receiving a RAN-CN interface message, which can be implemented in an MN;

FIG. 13 is a flow diagram of an example method for communicating an IMS packet to a UE during an MCG failure, which can be implemented in an MN;

FIG. 14 is a flow diagram of an example method for communicating an IMS packet with an MN or an SN during an MCG failure, which can be implemented in a UE;

FIG. 15 is a flow diagram of an example method for managing a connection between a network entity that supports packet-based calls and a UE in DC with an MN and an SN, which can be implemented in a node of a RAN; and

FIG. 16 is a flow diagram of an example method for managing a connection between a UE and a network entity that supports packet-based calls, which can be implemented in the UE.

### DETAILED DESCRIPTION OF THE DRAWINGS

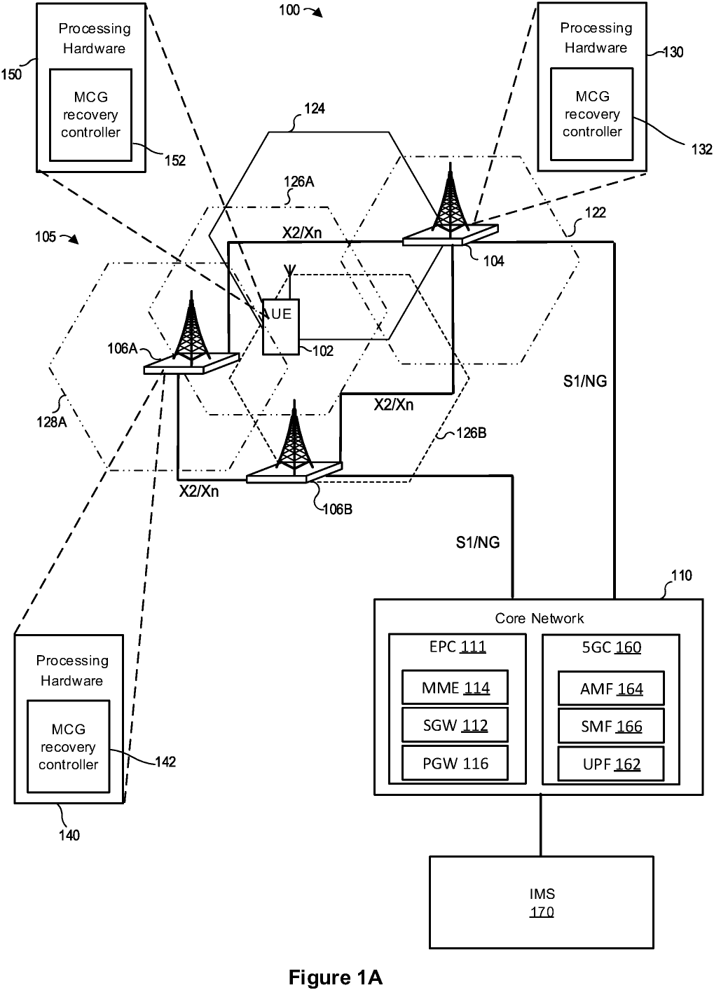

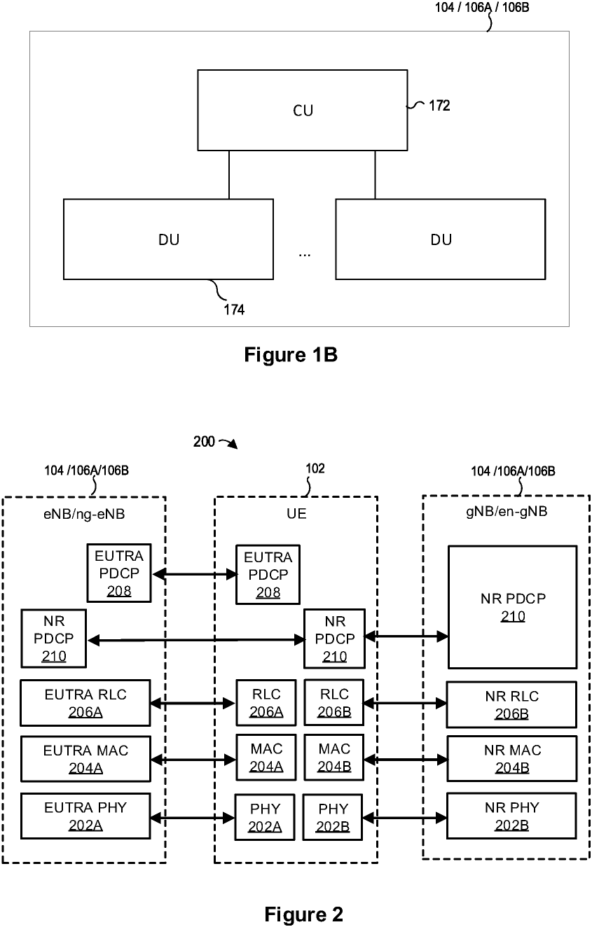

FIG. 1A depicts an example wireless communication system 100 in which communication devices can implement these techniques. The wireless communication system 100 includes a UE 102, a base station 104, a base station 106A, a base station 106B, and a core network (CN) 110. The UE 102 initially connects to the base station 104. The base stations 104, 106A, and 106B can operate in a RAN 105 connected to the CN 110. The CN 110 can be implemented as an evolved packet core (EPC) 111 or a fifth generation (5G) core (5GC), 160, for example. Depending on the implementation and/or scenario, the base station 106B may support a different radio access technology (RAT) from the MN and/or may be connected to a different core network, such as a core network implemented as a third generation (3G) core network (i.e., a UMTS core network).

Among other components, the EPC 111 can include a Serving Gateway (S-GW) 112, a Mobility Management Entity (MME) 114, and a Packet Data Network Gateway (P-GW) 116. Generally speaking, the S-GW 112 is configured to transfer user-plane packets related to audio calls, video calls, Internet traffic, etc., and the MME 114 is configured to manage authentication, registration, paging, and other related functions. The P-GW 116 provides connectivity from the UE to external packet data networks including an Internet Protocol (IP) Multimedia Subsystem (IMS) network by being the point of exit and entry of traffic for the UE. The 5GC 160 includes a User Plane Function (UPF) 162, an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions. In some implementations, the CN 110 can also include a UMTS core network not shown in FIG. 1A. The UMTS core network can include a mobile switching center (MSC), a Serving GPRS Support Node (SGSN), and/or a Gateway GPRS Support Node (GGSN).

As illustrated in FIG. 1A, the base station 104 supports a cell 124, the base station 106A supports a cell 126A, and the base station 106B supports a cell 126B. The base station 104 can additionally support a cell 122, and the base station 106A can additionally support a cell 128A. The cells 124 and 126A can partially overlap, so that the UE 102 can communicate in DC with the base station 104 and the base station 106A operating as a master node (MN) and a secondary node (SN), respectively. To directly exchange messages during DC scenarios and other scenarios discussed below, the MN 104 and the SN 106A can support an X2 or Xn interface. In general, the CN 110 can connect to any suitable number of base stations supporting NR cells and/or EUTRA cells.

In some scenarios, the base station 104 performs an immediate SN addition procedure to configure the UE 102 to operate in DC with the base station 104 and the base station 106A. The base stations 104 and 106A begin to operate as an MN and an SN for the UE 102, respectively. At a later time, the MN 104 can perform an immediate SN change tochange the SN of the UE 102 from the base station 106A (source SN, or “S-SN″) to the base station 106B (target SN, or “T-SN”) while the UE 102 is in DC with the MN 104 and the S-SN 106A. As discussed above, immediate procedures related to the SN, such as SN addition or SN change, do not include conditions to be satisfied prior to the UE performing the immediate procedures.

In some scenarios, the UE 102 may detect a master cell group (MCG) failure in communication with the MN 104, while the UE 102 is DC with the MN 104 and SN 106A. For example, the MCG failure can be a listen-before-talk or a radio link failure on MCG. In response to the detection, the UE 102 may transmit an MCG failure information message to the SN 106A via radio resources of the SN 106A (i.e., via secondary cell group (SCG) radio resources). In one implementation, the SN 106A forwards the MCG failure information message in an interface message (e.g., RRC Transfer message) to the MN 104 if the MN 104 comprehends MCG failure information messages. In response to receiving the MCG failure information message, the MN 104 may send the UE 102 an MCG failure recovery message to enable the UE 102 to recover the MCG failure via SCG radio resources. In one implementation, the MN 104 can send an interface message (e.g., RRC Transfer message) including the MCG failure recovery message to the SN 106A. In response, the SN 106A may allocate SCG radio resources to the UE 102. For example, the SCG radio resources include one or more physical resource blocks, resource elements or subcarriers in a time unit. The time unit can be one or more ODFM symbols, slots, or subframes. The UE 102 attempts to recover the MCG failure in accordance with the MCG failure recovery message.

With continued reference to FIG. 1, the base station 104 is equipped with processing hardware 130 that can include one or more general-purpose processors such as CPUs and non-transitory computer-readable memory storing machine-readable instructions executable on the one or more general-purpose processors, and/or special-purpose processing units. The processing hardware 130 in an example implementation includes an MCG recovery controller 132 configured to manage situations when the base station 104 operates as an MN, discussed with reference to the message and flow diagrams below.

The base station 106A is equipped with processing hardware 140 that can also include one or more general-purpose processors such as CPUs and non-transitory computer-readable memory storing machine-readable instructions executable on the one or more general-purpose processors, and/or special-purpose processing units. The processing hardware 140 in an example implementation includes an MCG recovery controller 142 configured to manage situations when the base station 106A operates as an SN, discussed with reference to the message and flow diagrams below. The base station 106B can have hardware that is the same as or similar to the base station 104 or the base station 106A.

Although FIG. 1 illustrates the MCG recovery controllers 132 and 142 as operating in an MN and an SN, respectively, a base station generally can operate as an MN and/or an SN in different scenarios. Thus, the base station 104, base station 106A, and the base station 106B can implement similar sets of functions and support both MN and/or SN.

Still referring to FIG. 1, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an MCG recovery controller 152 configured to manage situations where the UE 102 detects MCG failure, discussed with reference to the message and flow diagrams below.

In operation, the UE 102 can use a radio bearer (e.g., a DRB or an SRB) that at different times terminates at the MN 104 or the SN 106A. The UE 102 can receive a radio bearer configuration configuring the radio bearer from the MN 104 or the SN 106A. The UE 102 can apply one or more security keys when communicating on the radio bearer, in the uplink (from the UE 102 to a base station) and/or downlink (from a base station to the UE 102) direction. The UE 102 in some cases can use different RATs to communicate with the base stations 104 and 106A. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core networks or 5G NR-6G DC.

With continued reference to FIG. 1A, the CN 110 communicatively connects the UE 102, to an Internet Protocol (IP) Multimedia Subsystem (IMS) network 170, via the RAN 105. The IMS network 170 can provide to the UE 102 various IMS services, such as IMS short messages, IMS unstructured supplementary service data (USSD), IMS value added service data, IMS supplementary service data, IMS voice calls, and IMS video calls. To this end, an entity (e.g., a server or a group of servers) operating in the IMS network 170 supports packet exchange with the UE. The packets can convey signaling (such as session initiation protocol (SIP) messages, IP messages, or other suitable messages) as well as data (“or media”) such as voice or video. Although the techniques of this disclosure are discussed with specific reference to IMS, the CN 110 in general can connect to, or include, any suitable system that provides packet-based calls.

FIG. 1B depicts an example distributed implementation of a base station such as the base station 104, 106A, or 106B. The base station in this implementation can include a centralized unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 104, 106A or 106B operates as an MN or an SN. The process hardware may further include a physical layer controller configured to manage or control one or more physical layer operations or procedures.

FIG. 2 illustrates, in a simplified manner, an example radio protocol stack 200 according to which the UE 102 may communicate with an eNB/ng-eNB or a gNB (e.g., one or more of the base stations 104, 106A, 106B). In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP sublayer 210 over the EUTRA RLC sublayer 206A. The UE 102, in some implementations, additionally supports a UTRA stack to support handover or redirection between UTRA and EUTRA base stations and/or between UTRA and NR base stations.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide SRBs to exchange RRC messages, for example. On a user plane, the EUTRA PDCP sublayer 208 and the NR PDCP sublayer 210 can provide DRBs to support data exchange.

In scenarios where the UE 102 operates in EUTRA/NR DC (EN-DC), with the base station 104 operating as a master eNB (MeNB) and the base station 106A operating as an SgNB, the wireless communication system 100 can provide the UE 102 with an MN-terminated bearer that uses the EUTRA PDCP sublayer 208, or an MN-terminated bearer that uses the NR PDCP sublayer 210. In scenarios where the UE 102 operates in next generation (NG) EN-DC, with the base station 104 operating as a master ng-eNB (Mng-eNB) and the base station 106A operating as an SgNB, the wireless communication system 100 can provide the UE 102 with an MN-terminated bearer that uses the NR PDCP sublayer 208, or an MN-terminated bearer that uses the NR PDCP sublayer 210. In scenarios where the UE 102 operates in NR-DC (or NR-NR DC), with the base station 104 operating as a master gNB (MgNB) and the base station 106A operating as an SgNB, the wireless communication system 100 can provide the UE 102 with an MN-terminated bearer that uses the NR PDCP sublayer 208, or an MN-terminated bearer that uses the NR PDCP sublayer 210. In these scenarios above, the wireless communication system 100 in various scenarios can also provide the UE 102 with an SN-terminated bearer, which uses only the NR PDCP sublayer 210.

In scenarios where the UE 102 operates in NR/EUTRA DC (NE-DC), with the base station 104 operating as a MgNB and the base station 106A operating as a secondary ng-eNB, the wireless communication system 100 can provide the UE 102 with an MN-terminated bearer that uses the NR PDCP sublayer 208, or an MN-terminated bearer that uses the NR PDCP sublayer 210.

The MN-terminated bearer can be an MCG bearer using only MCG radio resources of an MN (e.g., the base station 104), an SCG bearer using only SCG radio resources of an SN (e.g., the base station 106A), or a split bearer using both the MCG radio resources of the MN and SCG radio resources of the SN. The SN-terminated bearer can be an MCG bearer, an SCG bearer or a split bearer.

An MN-terminated split bearer, for example, may terminate at a UE (e.g., the UE 102) and the MN, and route data between the UE and the MN through the SN: thus, the UE can exchange information with the core network (i) via the radio resources of the MN and over a link between the MN and the core network, or (ii) via the radio resources of the SN and over a link between the SN and the MN, and then over a link between the MN and the core network. An SN-terminated split bearer, for example, may terminate at a UE and the SN, and route data between the UE and the SN through the MN: thus, the UE can exchange information with the core network (i) via the radio resources of the SN and over a link between the SN and the core network, or (ii) via the radio resources of the MN and over a link between the SN and the MN, and then over a link between the SN and the core network.

The MN-terminated bearer can be an SRB (e.g., SRB1 or SRB2) or a DRB. The SN-terminated bearer can an SRB (e.g., SRB3) or a DRB. The MN-terminated or SN-terminated bearer can be associated with an MCG RLC bearer only, an SCG RLC bearer only, or both an MCG RLC bearer and an SCG RLC bearer.

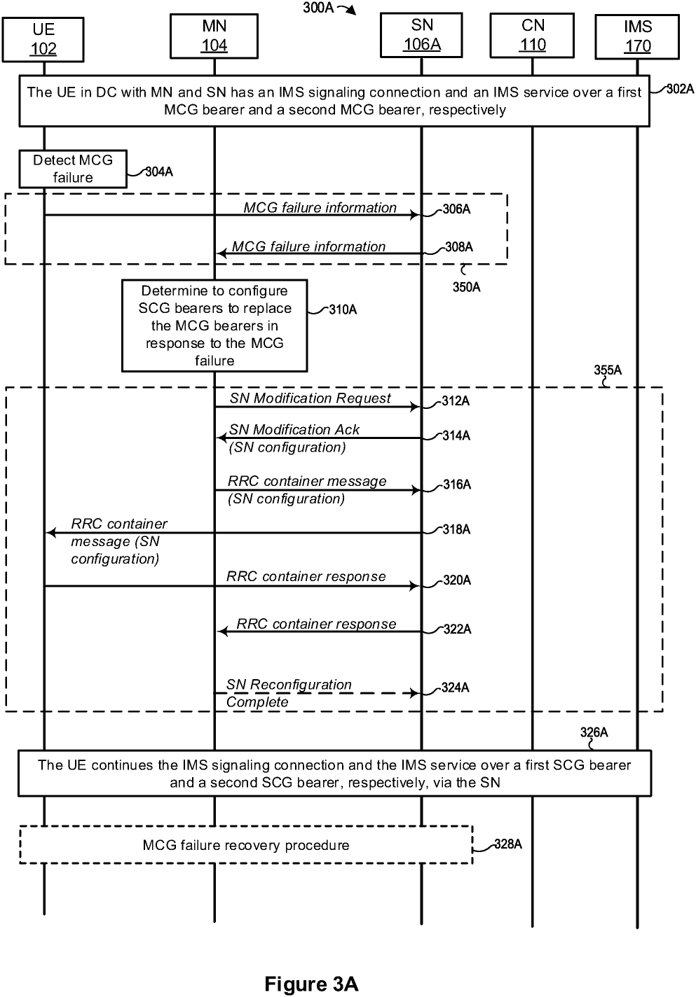

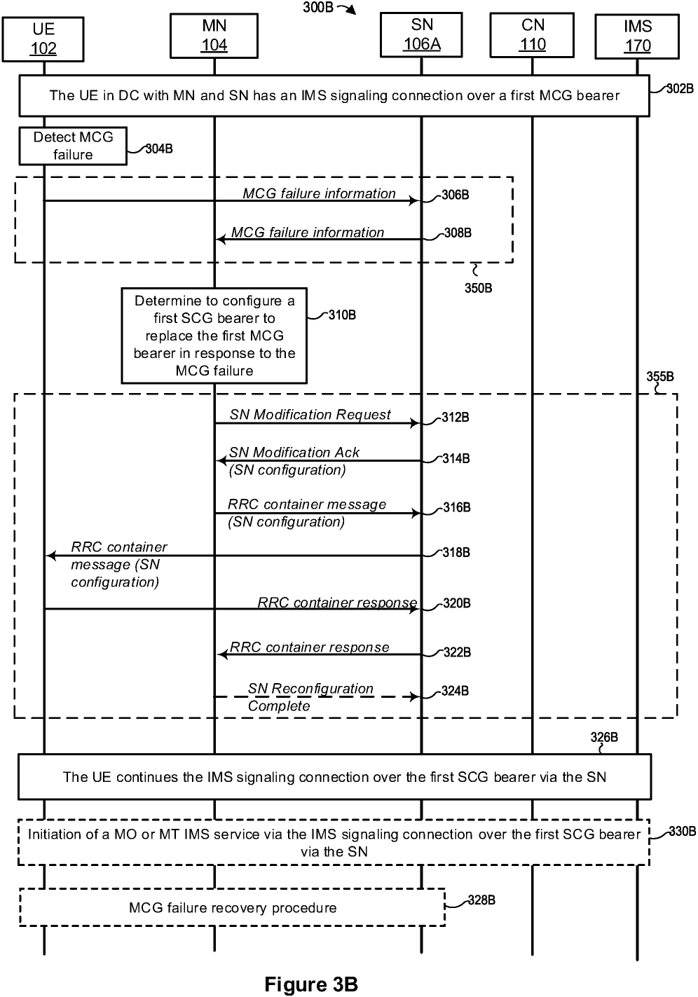

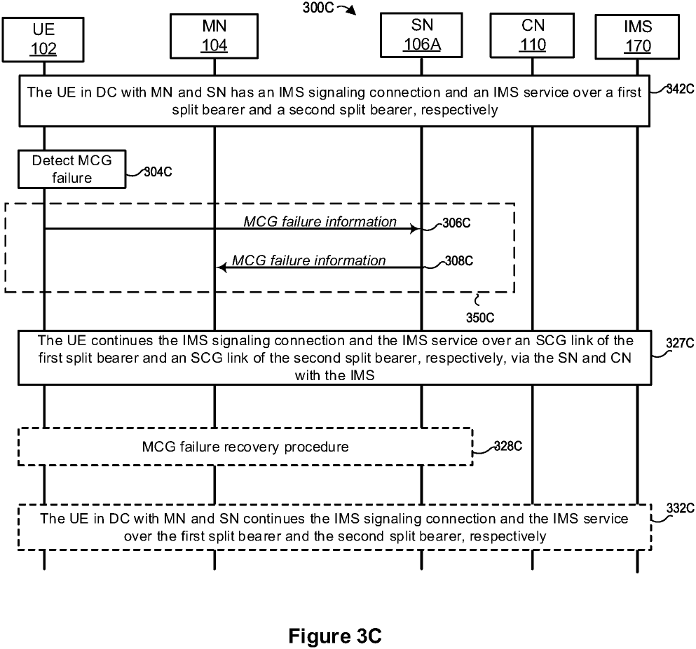

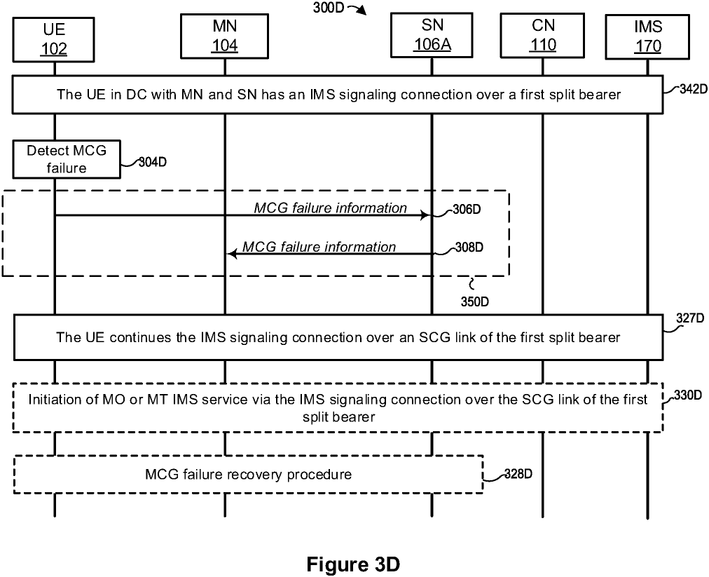

Next, FIGS. 3 through 9 illustrate message sequences between the UE 102 and various base stations of the RAN 105 (including base stations 104, 106A), in which the UE 102 and the base stations operating in the system of FIG. 1A manage IMS communications during MCG failure between the UE 102 and the RAN 105.

Referring first to FIG. 3A, the base station 104 in scenario 300A operates as an MN, and the base station 106A operates as an SN. Initially, the UE 102 operates 302A in DC with the MN 104 (via cell 124) and the SN 106A (via cell 126A) and has an IMS signaling connection and an IMS service with an IMS network 170 over a first MCG bearer and a second MCG bearer, respectively. In some implementations, the UE 102 in DC can transmit 302A IMS signaling messages (e.g., session initiation protocol (SIP) messages) and IMS media packets, such as voice or video packets (e.g., real-time transport protocol (RTP) packets), over the first MCG bearer and the second MCG bearer to the MN 104, respectively. The MN 104 can forward the IMS signaling messages and the IMS media packets to a CN 110 which in turn forwards the IMS signaling messages and the IMS media packets to the IMS network 170. In other implementations, the IMS network 170 can send IMS signaling messages (e.g., SIP messages) and IMS media packets (e.g., RTP packets) to the CN 110, which in turn forwards the IMS signaling messages and the IMS media packets to the MN 104. Then the MN 104 transmits 302A the IMS signaling messages and the IMS media packets over the first MCG bearer and the second MCG bearer to the UE 102 respectively.

Later in time, the UE 102 detects 304A an MCG failure, e.g., a listen-before-talk failure or a radio link failure on an MCG link configured by the MN 104. In response to the detection 304A, the UE 102 can suspend MCG transmissions (i.e., suspend transmissions on all of MCG link(s) with the MN 104) and transmit 306A an MCG failure information message to the SN 106A, which in turn sends 308A the MCG failure information message to the MN 104. The events 306A and 308A are collectively referred to in FIG. 3A as an MCG failure reporting procedure 350A.

In some implementations, the MN 104 can determine that an MCG failure has occurred at the UE 102 in response to receiving the MCG failure information message. In other implementations, the MN 104 determines that an MCG failure has occurred in response to not receiving a PDU or control signal(s) from the UE 102. For example, the PDU can be a MAC, RLC or PDCP PDU. In another example, the PDU can include an RRC message. The UE 102 can transmit the control signal(s) on control channel(s) which can be, for example, physical uplink control channel(s) (PUCCH(s)). In yet other implementations, the MN 104 determines that an MCG failure occurred at the UE 102 in response to receiving channel state information from the UE 102 that indicates invalid values or that downlink channel quality is bad.

In response to the MN 104 determining that an MCG failure occurred, the MN 104 determines 310A to configure a first SCG bearer and a second SCG bearer to replace the first MCG bearer and the second MCG bearer, respectively. In response to the determination 310A, the MN 104 sends 312A an SN Modification Request message to the SN 106A. In response, the SN 106A generates an SN configuration for configuring the first SCG bearer and the second SCG bearer and sends 314A an SN Modification Request Acknowledge message including the SN configuration to the MN 104. The MN 104 then sends 316A an RRC container message including the SN configuration to the SN 106A, which in turn transmits 318A the RRC container message to the UE 102. In response, the UE 102 transmits 320A an RRC container response message to the SN 106A, which in turn sends 322A the RRC container response message to the MN 104. The MN 104 can send 324A an SN Reconfiguration Complete message to the SN 106A in response to receiving the RRC container response message. The events 312A, 314A, 316A, 318A, 320A, 322A and 324A are collectively referred to in FIG. 3A as a bearer configuration procedure 355A.

In some implementations, the UE 102 can include an RRC reconfiguration complete message in the RRC container response message and the MN 104 can include the RRC reconfiguration complete message in the SN Reconfiguration Complete message. In some implementations, the MN 104 can send 316A a first MN-SN interface message (e.g., RRC Transfer message) including the RRC container message to the SN 106A. In other implementations, the SN 106A can send 322A a second MN-SN interface message (e.g., RRC Transfer message) including the RRC container response message to the MN 104.

After receiving the RRC container message, the UE 102 configures the first SCG bearer and the second SCG bearer in accordance with the RRC container message or the SN configuration the UE receives at event 318A. The UE 102 continues 326A the IMS signaling connection and the IMS service over the first SCG bearer and the second SCG bearer, respectively, via the RAN 105 (i.e., SN 106A, or the SN 106A and the MN 104) and the CN 110 with the IMS network 170. Thus, the UE 102 can communicate IMS media packets over the second SCG bearer with the SN 106A. In some implementations, the UE 102 transmits 326A IMS signaling messages (e.g., session initiation protocol (SIP) messages) over the first SCG bearer or transmits IMS media packets (e.g., real-time transport protocol (RTP) packets) over the second SCG bearer to the SN 106A. In one implementation, the SN 106A can forward the IMS signaling messages or the IMS media packets to the MN 104 which in turn forwards the IMS signaling messages or the IMS media packets to the CN 110. In another implementation, the SN 106A can forward the IMS signaling messages or the IMS media packets to the CN 110 via a RAN-CN interface between the SN 106A and the CN 110 (e.g., S1 or NG interface). In these implementations, the CN 110 in turn forwards the IMS signaling messages or the IMS media packets to the IMS network 170.

Similarly, the IMS network 170 can send IMS signaling messages (e.g., SIP messages) or IMS media packets (e.g., RTP packets) to the CN 110. In one implementation, the CN 110 in turn forwards the IMS signaling messages or the IMS media packets to the MN 104, which in turn forwards the IMS signaling messages or the IMS media packets to the SN 106A. In another implementation, the CN 110 in turn forwards the IMS signaling messages or the IMS media packets to the SN 106A via the RAN-CN interface. The SN 106A then transmits 326A the IMS signaling messages over the first SCG bearer or the IMS media packets over the second SCG bearer to the UE 102.

Later in time, the MN 104 can perform 328A an MCG failure recovery procedure with the UE 102 to recover the MCG failure. To perform the MCG failure recovery procedure, the MN 104 can send a handover command message to the SN 106A, which in turn transmits the handover command message to the UE 102, in some implementations. For example, the MN 104 can transmit a third MN-SN interface message (e.g., RRC Transfer message) including the handover command message to the SN 106A. The handover command message can indicate a target cell to which the UE 102 is to hand over, and the UE 102 can attempt to hand over to the target cell in response to the handover command message. The target cell can be operated by a target base station which can be the MN 104, SN 106A or base station 106B. In some implementations, the UE 102 can perform a random access procedure on the target cell to hand over to the target base station and transmits a handover complete message on the target cell to the base station during or after the random access procedure, e.g., without wrapping the handover complete message in another RRC message. The MN 104 can generate the handover command message, or receive the handover command message from the target base station directly (i.e., via a RAN interface between the MN 104 and the target base station) or via the CN 110 in a handover preparation procedure. If the IMS signaling connection or the IMS service still exists during the handover preparation procedure, the target base station can configure a third MCG bearer or a fourth MCG bearer replacing the first SCG bearer or the second SCG bearer, respectively, in the handover command message. After successfully completing the handover to the target base station on the target cell, the UE 102 can continue the IMS signaling connection and the IMS service over the third MCG bearer and the fourth MCG bearer respectively with target base station. The third MCG bearer can be the same as or different from the first MCG bearer. The fourth MCG bearer can be the same as or different from the second MCG bearer.

During the MCG failure, the SN 106A in some implementations includes MN DL RRC message(s) (received from the MN 104 in MN-SN interface message(s)) in SN DL RRC container message(s) and transmit the SN DL RRC container message(s) on SRB3 to the UE 102. Similarly, the UE 102 can include the MN UL RRC message(s) in SN UL RRC container message(s) and transmits the SN UL RRC container message(s) to the SN 106A on SRB3. The SN 106A extracts the MN UL RRC message(s) from the SN UL RRC container message(s), and sends MN-SN interface message(s) including the MN UL RRC message(s) to the MN 104.

For example, the MN DL RRC message(s) can be the RRC container message 318A and/or the handover command message, and the MN UL RRC message(s) can be the RRC container response message 320A. In some implementations, the SN DL RRC container message(s) can be DLInformationTransferMRDC message(s) and the SN UL RRC container message(s) can be ULInformationTransferMRDC message(s). In other implementations, the MN-SN interface message(s) including the MN DL RRC message(s) can be RRC Transfer message(s). The MN 104 can include the MN DL RRC message(s) in a Fast MCG Recovery via SRB3 from MN to SN IE in the RRC Transfer message(s). In yet other implementations, the MN-SN interface message(s) including the MN UL RRC message(s) can be RRC Transfer message(s). The SN 106A can include the MN UL RRC message(s) in a Fast MCG Recovery via SRB3 from SN to MN IE in the RRC Transfer message(s).

During the MCG failure, the SN 106A in some implementations transmits MN DL RRC message(s) (received from the MN 104 in MN-SN interface message(s)) on an SCG link (i.e., SCG radio resources of the SN 106A) of a split SRB1 to the UE 102 without wrapping the MN DL RRC message(s) in SN RRC container message(s). Similarly, the UE 102 transmits the MN UL RRC message(s) to the SN 106A on an SCG link of the split SRB1 without wrapping the MN UL RRC message(s) in SN UL RRC message(s). The SN 106A sends MN-SN interface message(s) including the MN UL RRC message(s) to the MN 104.

For example, the MN DL RRC message(s) can be the RRC container message 318A and/or the handover command message, and the MN UL RRC message(s) can be the RRC container response message 320A. In some implementations, the MN-SN interface message(s) including the MN DL RRC message(s) can be RRC Transfer message(s). The MN 104 can include the MN DL RRC message(s) in a Split SRB IE in the RRC Transfer message(s). In other implementations, the MN-SN interface message(s) including the MN UL RRC message(s) can be RRC Transfer message(s). The SN 106A can include the MN UL RRC message(s) in a UE Report IE or a Split SRB IE in the RRC Transfer message(s).

In this disclosure, during the MCG failure, that the UE 102 communicates RRC message(s) (i.e., the MN UL RRC message(s) and/or the MN DL RRC message(s)) with the RAN 105 can mean that the UE 102 communicates with the MN 104 via the SN 106A as described above, unless otherwise described.

In some scenarios and implementations, the MN 104 can perform an SN addition procedure with the base station 106A to configure the base station 106A as an SN for the UE 102 before the event 302A. In the SN addition procedure, the MN 104 sends an SN Addition Request message to the base station 106A. In response, the SN 106A transmits an SN Addition Request Acknowledge message including an RRC reconfiguration message to the MN 104. The MN 104 then transmits a first RRC container message including the RRC reconfiguration message to the UE 102 via MCG radio resources. The UE 102 can transmit a first RRC container response message to the MN 104 in response to the first RRC container message via MCG radio resources. After receiving the first RRC container response message, the MN 104 can send an SN Reconfiguration Complete message to the SN 106A to indicate to the SN 106A that the UE 102 successfully received or applied the RRC reconfiguration message. In one implementation, the UE 102 can include an RRC reconfiguration complete message in the first RRC container response message in response to the RRC reconfiguration message and the MN 104 can include the RRC reconfiguration complete message in the SN Reconfiguration Complete message.

The MN 104 can receive a UE capability of the UE 102 from the UE 102 in a UECapabilityInformation message, from another base station (e.g., base station 106B) in a RAN interface message, or from the CN 110 in a RAN-CN interface message. The UE capability indicates whether the UE 102 is capable of performing an MCG fast recovery function (i.e., the UE 102 is capable of performing the MCG failure reporting procedure 350A and the MCG failure recovery procedure 328A). In one implementation, the UE capability can include a first field indicating the UE 102 is capable of the performing the MCG fast recovery function. For example, the first field can be mcgRLF-RecoveryViaSCG-r16. If the UE capability does not include the first field, this may indicate that the UE 102 does not support the MCG fast recovery function.

In some implementations, the MN 104 can configure the UE 102 to enable the MCG fast recovery function in the first RRC container message in response to the MN 104 determining that the UE 102 supports the MCG fast recovery function based on the UE capability and that the SN 106A supports MCG fast recovery operation (i.e., the SN 106A can forward an MN UL RRC message (received from the UE 102) to the MN 104 and/or forward an MN DL RRC message (received from the MN 104) to the UE 102 as described above). In some implementations, the RAN interface message can be an X2 message or Xn message (e.g., Handover Request message or Retrieve UE Context Request message). The RAN-CN interface message can be a S1AP message or a NGAP message (e.g., Initial Context Setup Request message or Handover Request message). In some implementations, the SN 106A can indicate that the SN 106A supports MCG fast recovery operation in the SN Addition Request Acknowledge message, and the MN 104 can determine that the SN 106A supports the MCG fast recovery operation based on the SN Addition Request Acknowledge message. In other implementations, the MN 104 can determine that the SN 106A supports the MCG fast recovery operation according to a pre-configuration. In other implementations, the MN 104 can determine that the SN 106A supports the MCG fast recovery operation according to a received indication from an operation and maintenance (O&M) server. Alternatively, the MN 104 can configure the UE 102 to enable the MCG fast recovery function in a second RRC container message and transmit the second RRC container message to the UE 102 after the UE 102 is in DC with the MN 104 and SN 106A. The UE 102 can transmit a second RRC container response message to the MN 104 in response to the second RRC container message.

If the MN 104 determines that a UE (e.g., the UE 102 or another UE) does not support the MCG fast recovery function or that the SN 106A does not support MCG fast recovery operation, then the MN 104 does not configure the UE to enable the MCG fast recovery function.

In some implementations, the UE 102 may mandatorily support an IMS service and/or IMS signaling connection over an MCG bearer. In such implementations, the UE capability may not include a field indicating the UE 102 supports an IMS service or IMS signaling connection over an MCG bearer, e.g., for EN-DC, NGEN-DC, NR-DC and/or NE-DC. For example, the UE 102 may mandatorily support IMS voice over an MCG bearer and/or may mandatorily support IMS signaling connection over an MCG bearer.

In other implementations, the UE capability can indicate that the UE 102 supports an IMS service and/or IMS signaling connection over an MCG bearer. For example, the UE capability can indicate that the UE 102 supports IMS voice over an MCG bearer. In another example, the UE capability can indicate that the UE 102 supports an IMS signaling connection over an MCG bearer.

In some implementations, the UE 102 may mandatorily support an IMS service and/or IMS signaling connection over an SCG bearer. In such implementations, the UE capability may not include a field indicating the UE 102 supports an IMS service and/or IMS signaling connection over an MCG bearer, e.g., for EN-DC, NGEN-DC, NR-DC and/or NE-DC. For example, the UE 102 may mandatorily support IMS voice over an SCG bearer and/or may mandatorily support IMS signaling connection over an SCG bearer.

In other implementations, the UE capability can indicate that the UE 102 supports an IMS service and/or IMS signaling connection over an SCG bearer, e.g., for EN-DC, NGEN-DC, NR-DC and/or NE-DC. Because the UE capability indicates that the UE 102 supports an IMS service and/or signaling connection over an SCG bearer, the MN 104 makes the determination 310A. If a UE capability of a UE (e.g., the UE 102 or another UE) indicates that the UE does not support an IMS service and/or signaling connection over an SCG bearer, then the MN 104 does not make the determination 310A.

In some implementations, the MN 104 may determine to configure the second SCG bearer for the IMS service because the UE capability indicates that the UE 102 supports the IMS service over an SCG bearer. If a UE capability of a UE (e.g., the UE 102 or another UE) indicates that the UE does not support the IMS service over an SCG bearer, then the MN 104 does not configure the second SCG bearer for the IMS service. In some implementations, the MN 104 may determine to configure the first SCG bearer for the IMS signaling connection because the UE capability indicates that the UE 102 supports the IMS service over an SCG bearer. In other implementations, the MN 104 may determine to configure the first SCG bearer for the IMS signaling connection in response to the MCG failure, irrespective of whether the UE capability indicates that the UE 102 supports the IMS service over an SCG bearer.

In some implementations, the UE capability can be a UE-EUTRA-Capability IE, a UE-NR-Capability IE or a UE-MRDC-Capability IE. For example, the UE capability can include a second field which indicates the UE supports the IMS service (e.g., IMS voice) over an SCG bearer. If the UE capability does not include the second field, then UE 102 does not support IMS voice over an SCG bearer. The second field can, for example, be ims-VoiceOverNR-PDCP-SCG-Bearer-r15 in case of EN-DC, ims-VoNR-PDCP-SCG-NGENDC-r15 in case of NGEN-DC, voiceOverSCG-BearerNR in case of NR-DC and voiceOverSCG-BearerEUTRA-5GC in case of NE-DC. If the UE capability does not include the second field for the corresponding DC (i.e., EN-DC, NG EN-DC, NR-DC or NE-DC), then UE 102 does not support the IMS service over SCG bearer for the corresponding DC. Alternatively, the UE 102 may mandatorily support the IMS service over SCG bearers for NR-DC, and correspondingly the UE capability may not include a field indicating that the UE 102 supports the IMS service over SCG bearers for NR-DC.

In some implementations, at event 302A, the MN 104 and/or the SN 106A can transmit at least one radio bearer configuration (e.g., RadioBearerConfig IE(s)) configuring (i.e., adding or modifying) one or more radio bearers, which can be MN-terminated bearer(s) or SN-terminated bearer(s), to the UE 102. The one or more radio bearers can include DRB(s), the SRB3, the split SRB1, and/or the split SRB2. Alternatively, the one or more radio bearers can include a non-split SRB1 or a non-split SRB2 instead of the split SRB1 or the split SRB2. The DRB(s) includes the first MCG bearer and the second MCG bearer. The DRB(s) can additionally include an MCG bearer, a split bearer, or an SCG bearer not described above. The UE 102 configures the one or more radio bearers according to the at least one radio bearer configuration. The target base station can configure MCG bearer(s) replacing the additional MCG, split or SCG bearer(s), respectively, in the handover command message.

In some implementations, the MN 104 can receive one of the at least one radio bearer configuration from the SN 106A in the SN Addition Request Acknowledge message and includes the radio bearer configuration in the first RRC container message. In other implementations, the MN 104 can generate one of the radio bearer configurations and include the radio bearer configuration in the first RRC container message. In other implementations, the MN 104 can include one of the at least one radio bearer configuration in a third RRC container message and transmit the third RRC container message to the UE 102 after the UE 102 is in DC with the MN 104 and SN 106A. The UE 102 can transmit a third RRC container response message to the MN 104 in response to the third RRC container message.

After receiving the RRC reconfiguration message in the first RRC container message, the UE 102 can perform a random access procedure on cell 126A with the SN 106A to connect to the SN 106A using one or more random access configuration in the RRC reconfiguration message. Once the UE 102 successfully completes the random access procedure on the cell 126A, the UE 102 in DC with the MN 104 and the SN 106A can communicate data (user-plane data or control-plane data) with the MN 104 via MCG radio resources and with the SN 106A through the cell 126A via SCG radio resources. Similarly, once the SN 106A identifies the UE 102 in the random access procedure, the SN 106A then can communicate data (user-plane data or control-plane data) with the UE 102 through the cell 126A.

In some implementations, the MN 104 includes, in the RRC container message 316A, at least one radio bearer configuration (e.g., RadioBearerConfig IE(s)) for configuring the first SCG bearer and/or the second SCG bearer to replace the first MCG bearer and/or the second MCG bearer or reconfiguring the first MCG bearer and/or the second MCG bearer to be the first SCG bearer and/or the second SCG bearer. In one implementation, the SN 106A includes the at least one radio bearer configuration in the SN Modification Acknowledge message 314A. In another implementation, the SN 106A includes a first radio bearer configuration in the SN Modification Acknowledge message 314A and the MN 104 generates a second radio bearer configuration. The first radio bearer configuration configures the first and second SCG bearers and the second radio bearer configuration releases the first and second MCG bearers. In yet another implementation, the MN 104 generates the at least one radio bearer configuration.

In other implementations, the MN 104 does not include a radio bearer configuration in the RRC container message 316A.

In some implementations, the SN configuration can include multiple configuration parameters that configure SCG radio resources for the UE 102 to communicate with the SN 106A via a PSCell (e.g., the cell 126A or a cell other than cell 126A) and zero, one, or more SCells of the SN 106. For example, the SN configuration can include PHY configuration(s), MAC configuration(s), and/or RLC configuration(s) (e.g., RLC-BearerConfig IE(s)), or include a cell group configuration (e.g., CellGroupConfig IE). The SN configuration can configure the RLC configuration(s) for the first SCG bearer and the second SCG bearer. If the RRC container message 316A includes the at least one radio bearer configuration, the UE 102 uses the RLC configuration(s) and the at least one radio bearer configuration to configure the first and second SCG bearers (e.g., SN-terminated bearer with SCG RLC bearers). If the RRC container message 316A does not include a radio bearer configuration, the UE 102 reconfigures the first and second MCG bearers with the RLC configuration(s) to be the first and second MCG bearers (e.g., MN-terminated bearer with SCG RLC bearers).

In some implementations, the SN configuration includes configuration parameters in an RRCReconfiguration message, RRCReconfiguration-IEs, or a CellGroupConfig IE conforming to 3GPP TS 38.331. In one implementation, the SN configuration can be included in an RRCReconfiguration message, RRCReconfiguration-IEs, or a CellGroupConfig IE conforming to 3GPP TS 38.331. In other implementations, the SN configuration can include configuration parameters in an SCG-ConfigPartSCG-r12 IE. In some implementations, the SN configuration can be included in an RRCConnectionReconfiguration message, RRCConnectionReconfiguration-IEs, or a ConfigPartSCG-r12 IE conforming to 3GPP TS 36.331.

In some implementations, the handover command message can be an RRC reconfiguration message including a mobility field (e.g., mobilityControlInfo or reconfigurationWithSync). The handover complete message can be an RRC reconfiguration complete message.

In some implementations, if the MN 104 is a gNB, the RRC container message and the RRC container response message can be an RRCReconfiguration message and an RRCReconfigurationComplete message, respectively. In other implementations, if the MN 104 is an eNB or ng-eNB, the RRC container message and the RRC container response message can be an RRCConnectionReconfiguration message and an RRCConnectionReconfigurationComplete message, respectively.

In some implementations, if the SN 106A is a gNB, the RRC reconfiguration message and the RRC reconfiguration complete message described above can be an RRCReconfiguration message and an RRCReconfigurationComplete message, respectively. In other implementations, if the SN 106A is an eNB or ng-eNB, the RRC reconfiguration message and the RRC reconfiguration complete message described above can be an RRCConnectionReconfiguration message and an RRCConnectionReconfigurationComplete message, respectively.

Referring next to FIG. 3B, a scenario 300B involves MCG failure during an IMS connection similar to the scenario 300A. In scenario 300B, the base station 104 operates as an MN and the base station 106A operates as an SN. Events in the scenario 300B similar to those discussed above with respect to the scenario 300A are labeled with similar reference numbers (e.g., with event 302A of FIG. 3A corresponding to event 302B of FIG. 3B). With the exception of the differences shown in FIG. 3B and the differences described below, any of the alternative implementations discussed above with respect to the scenario 300A (e.g., for messaging and processing) may apply to the scenario 300B.

Initially, the UE 102 operates 302B in DC with the MN 104 (via cell 124) and the SN 106A (via cell 126A) and has an IMS signaling connection with an IMS network 170 over a first MCG bearer. Different from FIG. 3A, the UE 102 does not have an IMS service and a second MCG bearer for an IMS service before event 330B. In response to the MN 104 determining that an MCG failure occurred at the UE 102 (e.g., based on receiving 308B an MCG failure information message), the MN 104 determines 310B to configure a first SCG bearer replacing the first MCG bearer. The events 312B, 314B, 316B, 318B, 320B, 322B and 324B are collectively referred to in FIG. 3B as a bearer configuration procedure 355B. The bearer configuration procedure 355B is similar to the bearer configuration procedure 355A, except that the bearer configuration procedure 355B does not involve a second MCG bearer or a second SCG bearer.

While the UE 102 continues 326B the IMS signaling connection over the first SCG bearer via the RAN 105 (e.g., the SN 106A, or the SN 106A and the MN 104) and the CN 110 with the IMS network 170, the UE 102 can initiate 330B a mobile originating (MO) IMS service via the IMS signaling connection over the first SCG bearer via the RAN 105 and the CN 110 with the IMS network 170. The UE 102 exchanges (i.e. sends and receives) IMS signaling messages (e.g., SIP messages) over the IMS signaling connection with the IMS network 170 to perform the MO IMS service.

Additionally or alternatively, while the UE 102 continues 326B the IMS signaling connection over the first SCG bearer via the RAN 105 (e.g., the MN 104, the SN 106A, or the SN 106A and the MN 104) and the CN 110 with the IMS network 170, the IMS network 170 can initiate 330B a mobile terminating (MT) IMS service via the IMS signaling connection over the first SCG bearer via the RAN 105 and the CN 110 with the UE 102. The IMS network 170 exchanges (i.e. sends and receives) IMS signaling messages (e.g., SIP messages) over the IMS signaling connection with the UE 102 to perform the MT IMS service.

In some implementations, the MO or MT IMS service can be an IMS short message service, an IMS USSD service, an IMS value added service, an IMS supplementary service, an IMS voice call, or an IMS video call. To simplify the following description, an IMS connection can represent an IMS signaling connection and/or a MO/MT IMS service. An IMS packet can represent an IMS signaling message or an IMS service data packet (where data packet is also referred to herein as a media packet) (e.g., IMS voice packet, IMS video packet, IMS short message, etc.).

In some implementations, the CN 110 can send a first RAN-CN interface message to request that the RAN 105 set up a radio bearer or a quality of service (QoS) flow for the IMS service during or after event 330B. For example, the CN 110 may do so if the IMS service is an IMS voice service or an IMS video service. The CN 110 may not do so if the IMS service is neither an IMS voice or an IMS video service. The RAN 105 configures a radio bearer (e.g., the first SCG bearer, a second SCG bearer, or a second MCG bearer) or QoS flow over the radio bearer for the IMS service for the UE 102 in response to the first RAN-CN interface message. For example, the first RAN-CN interface message may be a NGAP message (e.g., PDU SESSION RESOURCE MODIFY REQUEST message) or a S1AP message (e.g., E-RAB SETUP REQUEST message).

In some implementations, the MN 104 can transmit to the UE 102 directly or via the SN 106A a first RRC reconfiguration message to configure for the UE 102 the first MCG bearer or a first QoS flow over the first MCG bearer for the IMS signaling connection at event 302B. In response, the UE 102 can transmit a first RRC reconfiguration complete message to the MN 104 directly or via the SN 106A. The first QoS flow can be associated with a first QoS setting including multiple QoS parameters. The CN 110 can provide the first QoS setting to the RAN 105 in a second RAN-CN interface message similar to the first RAN-CN interface message. The UE 102 and the RAN 105 or the CN 110 can exchange IMS signaling messages over the first QoS flow over the first MCG bearer. The UE 102, the RAN 105 and/or the CN 110 enforces the first QoS setting for IMS signaling messages exchanged over the first QoS flow.

In some implementations, the RAN 105 can configure the first QoS flow over the first SCG bearer for the UE 102 in the bearer configuration procedure 355B so that the UE 102 can configure the first QoS flow over the first SCG bearer in response to the RRC container message at event 318B. The UE 102 and the RAN 105 or the CN 110 can exchange IMS signaling messages over the first QoS flow over the first SCG bearer. The UE 102, the RAN 105 and/or the CN 110 enforce the first QoS setting for IMS signaling messages exchanged over the first QoS flow.

In some implementations, the RAN 105 can configure for the UE 102 a second QoS flow for the IMS service in response to the first RAN-CN interface message. The second QoS flow can be associated with a second QoS setting including multiple QoS parameters and different the first QoS setting. The CN 110 can provide the second QoS settings to the RAN 105 in the first RAN-CN interface message. The UE 102 and the RAN 105 or the CN 110 can exchange IMS media packets over the second QoS flow with one another.

In some implementations, if the RAN 105 receives the first RAN-CN interface message from the CN 110 before the MCG failure is recovered by the MCG failure recovery procedure, the RAN 105 can perform a bearer configuration procedure (e.g., similar to the bearer configuration procedure 355B) to configure the UE 102 a second SCG bearer for the IMS service or the second QoS flow over the second SCG bearer in response to the first RAN-CN interface message. After setting up the second SCG bearer or the second QoS flow over the second SCG bearer as configured by the RAN 105, the UE 102 transmits IMS media packets over the second SCG bearer or the second QoS flow to the RAN 105, which forwards the IMS media packets to the CN 110. In one implementation, the UE 102 transmits IMS media packets over the second SCG bearer or the second QoS flow to the SN 106A, which forwards the IMS media packets to the CN 110. In another implementation, the UE 102 transmits IMS media packets over the second SCG bearer or the second QoS flow to the SN 106A, which forwards the IMS media packets to the MN 104. The MN 104 then forwards the IMS media packets to the CN 110, which in turn forwards the IMS media packets to the IMS network 170. Similarly, after configuring the second SCG bearer or the second QoS flow over the second SCG bearer, the UE 102 receives IMS media packets over the second SCG bearer or the second QoS flow from the RAN 105, which receives the IMS media packets from the CN 110 via the first RAN-CN interface. The CN 110 receives the IMS media packets from the IMS network 170. In one implementation, the CN 110 sends the IMS media packets to the SN 106A which in turn transmits the IMS media packets over the second SCG bearer or the second QoS flow to the UE 102. In another implementation, the CN 110 sends the IMS media packets to the MN 104 which in turn forwards the IMS media packets to the SN 106A. The SN 106A then transmits the IMS media packets to the UE 102 via the second SCG bearer or the second QoS flow. The first and second SCG bearers can be the same or different bearers.

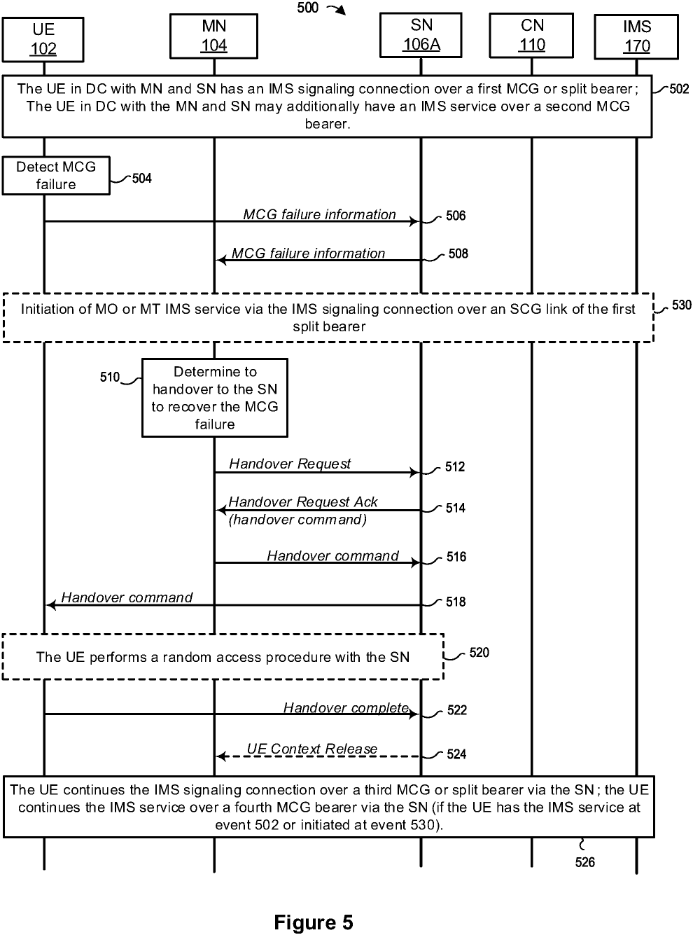

In other implementations, if the MN 104 receives the first RAN-CN interface message from the CN 110 while the MN 104 is preparing the MCG failure recovery procedure (e.g., a handover procedure), the MN 104 can transmit a handover command message configuring a second MCG bearer or the second QoS flow over the second MCG bearer to the UE 102 in the MCG failure recovery procedure. In some of these implementations, the MN 104 includes configuration parameters configuring the second MCG bearer or the second QoS flow over the second MCG bearer in the handover command message. In other implementations, the MN 104 prepares the handover procedure with a target base station for the UE 102 and the target base station includes configuration parameters configuring the second MCG bearer or the second QoS flow over the second MCG bearer in the handover command message, which can be similar to events 512, 514, 516, 518, 520 and 522, discussed below with reference to FIG. 5. The configuration parameters may include a radio bearer configuration (e.g., a RadioBearerConfig IE or a DRB-ToAddMod) and/or an RLC configuration (e.g., an RLC-BearerConfig IE or RLC-Config IE). The first and second MCG bearers can be the same or different bearers.

In yet other implementations, if the MN 104 receives the first RAN-CN interface message from the CN 110 after the MCG failure is recovered by the MCG failure recovery procedure at event 328B, the MN 104 can transmit to the UE 102 on an SRB (e.g., SRB1) an RRC reconfiguration message configuring a second MCG bearer for the IMS service or the second QoS over the second MCG bearer. In response, the UE 102 can transmit an RRC reconfiguration complete message to the MN on the SRB. The UE 102 and the MN 104 can exchange the RRC reconfiguration message and the RRC reconfiguration complete message via MCG radio resources. In one implementation, the MN 104 includes configuration parameters configuring the second MCG bearer in the RRC reconfiguration message. After configuring the second MCG bearer or the second QoS flow over the second MCG bearer, the UE 102 transmits IMS media packets over the second MCG bearer or the second QoS flow to MN 104, which forwards the IMS media packets to the CN 110. The CN 110 forwards the IMS media packets to the IMS network 170. Similarly, after configuring the second MCG bearer or the second QoS flow over the second MCG bearer, the UE 102 receives IMS media packets over the second MCG bearer or the second QoS flow from the MN 104, which receives the IMS media packets from the CN 110. The CN 110 receives the IMS media packets from the IMS network 170. The configuration parameters may include a radio bearer configuration (e.g., a RadioBearerConfig IE or a DRB-ToAddMod) and/or an RLC configuration (e.g., an RLC-BearerConfig IE or RLC-Config IE). The first and second MCG bearers can be the same or different bearers.

In yet other implementations, if the MN 104 receives the first RAN-CN interface message from the CN 110 during the MCG failure, the MN 104 may reject setting up a radio bearer for the UE 102.

The MN 104 can send a third RAN-CN interface message to the CN 110 in response to the first RAN-CN interface message. In the third RAN-CN interface message, the MN 104 can indicate whether the MN 104 accepts or rejects setting up resources (e.g., a radio bearer) for a PDU Session or Evolved Packet System (EPS) radio access bearer. In some implementations, the third RAN-CN interface message can be a PDU SESSION RESOURCE MODIFY RESPONSE message or E-RAB SETUP RESPONSE message.

In some implementation, if the MN 104 is a gNB, the RRC reconfiguration message and the RRC reconfiguration complete message described above can be an RRCReconfiguration message and an RRCReconfigurationComplete message, respectively. In other implementations, if the MN 104 is an eNB or ng-eNB, the RRC reconfiguration message and the RRC reconfiguration complete message described above can be an RRCConnectionReconfiguration message and an RRCConnectionReconfigurationComplete message, respectively.

Referring next to FIG. 3C, a scenario 300C involves MCG failure during an IMS connection similar to the scenario 300A. In scenario 300C, the base station 104 operates as an MN and the base station 106A operates as an SN. As mentioned above, events in the scenario 300C similar to those discussed above with respect to the scenario 300A are labeled with similar reference numbers (e.g., with event 304A of FIG. 3A corresponding to event 304C of FIG. 3C). With the exception of the differences shown in FIG. 3C and the differences described below, any of the alternative implementations discussed above with respect to the scenario 300A (e.g., for messaging and processing) may apply to the scenario 300C.

Initially, the UE 102 operates 342C in DC with the MN 104 (via cell 124) and the SN 106A (via cell 126A) has an IMS signaling connection and an IMS service with an IMS network 170 over a first split bearer and a second split bearer, respectively. The UE 102 in DC can communicate 342C IMS signaling messages (e.g., SIP messages) over the first split bearer with the MN 104 or the SN 106A. The UE 102 in DC can communicate 342C IMS media packets (e.g., RTP packets) over the second split bearer with the MN 104 only, the SN 106A only, or both the MN 104 and the SN 106A.

In some implementations, the UE 102 transmits 342C the IMS signaling messages only over an MCG link, an SCG link or both the MCG and SCG links of the first split bearer to the MN 104. Similarly, the UE 102 transmits 342C the IMS media packets only over an MCG link, an SCG link or both the MCG and SCG links of the second split bearer to the MN 104. In other implementations, the UE 102 transmits 342C the IMS signaling messages only over an MCG link, an SCG link or both the MCG and SCG links of the first split bearer to the SN 106A. Similarly, the UE 102 transmits 342C the IMS media packets only over an MCG link, an SCG link, or both the MCG and SCG links of the second split bearer to the SN 106A. In some implementations, the MN 104 can forward the IMS signaling messages and/or the IMS media packets to a CN 110 via a RAN-CN interface (between the MN 104 and the CN 110). Alternatively, the MN 104 can forward the IMS signaling messages and/or the IMS media packets to the SN 106A which in turn forwards the IMS signaling messages and/or the IMS media packets to the CN 110. In other implementations, the SN 106A can forward the IMS signaling messages and/or the IMS media packets to the CN 110 via a RAN-CN interface (between the SN 106A and the CN 110). Alternatively, the SN 106A can forward the IMS signaling messages and/or the IMS media packets to the MN 104 which in turn forwards the IMS signaling messages and/or the IMS media packets to the CN 110. After receiving the IMS signaling messages and/or the IMS media packets, the CN 110 forwards the IMS signaling messages and/or the IMS media packets to the IMS network 170.

If the first split bearer is an MN-terminated split bearer, the UE 102 in DC can transmit 342C IMS signaling messages (e.g., SIP messages) over the first split bearer to the MN 104. If the second split bearer is an MN-terminated split bearer, the UE 102 in DC can transmit 342C IMS media packets (e.g., RTP packets) over the second split bearer to the MN 104. If the first split bearer is an SN-terminated split bearer, the UE 102 in DC can transmit 342C IMS signaling messages (e.g., SIP messages) over the first split bearer to the SN 106A. If the second split bearer is an SN-terminated split bearer, the UE 102 in DC can transmit 342C IMS media packets (e.g., RTP packets) over the second split bearer to the SN 106A.

The IMS network 170 can send IMS signaling messages (e.g., SIP messages) and IMS media packets (e.g., RTP packets) to the CN 110, which in turn forwards the IMS signaling messages and the IMS media packets to the MN 104 or the SN 106A. Then the MN 104 or the SN 106A transmits 342C the IMS signaling messages and the IMS media packets over the first split bearer and the second split bearer to the UE 102 respectively. In some implementations, the MN 104 or the SN 106A transmits 342C the IMS signaling messages only over an MCG link, an SCG link, or both the MCG and SCG links of the first split bearer the UE 102, and the MN 104 or the SN 106A transmits 342C the IMS media packets only over an MCG link, an SCG link, or both the MCG and SCG links of the second split bearer to the UE 102.

In some implementations, the MN 104 can forward the IMS signaling messages and/or the IMS media packets to the SN 106A which in turn transmits the IMS signaling messages and/or the IMS media packets over the first split bearer and/or the second split bearer respectively to the UE 102. The MN 104 may do so if the first split bearer is an SN-terminated split bearer and/or the second split bearer is an SN-terminated split bearer. In other implementations, the SN 106A can forward the IMS signaling messages and/or the IMS media packets to the MN 104 which in turn transmits the IMS signaling messages and/or the IMS media packets over the first split bearer and/or the second split bearer respectively to the UE 102. The SN 106A may do so if the first split bearer is an MN-terminated split bearer and/or the second split bearer is an MN-terminated split bearer.

After the UE 102 detects 304C an MCG failure, the UE 102 continues 327C the IMS signaling connection over an SCG link of the first split bearer via the RAN 105 (i.e., the SN 106A and/or the MN 104) and CN with the IMS network 170. Likewise, after the UE 102 determines 304C MCG failure, the UE continues 327C the IMS service over an SCG link of the second split bearer via the RAN 105 and CN with the IMS network 170. During the MCG failure, the UE 102 can communicate 327C IMS signaling messages (e.g., SIP messages) over an SCG link of the first split bearer with the RAN 105. During the MCG failure, the UE 102 can communicate 327C IMS media packets (e.g., RTP packets) over an SCG link of the second split bearers with the RAN 105.

To continue 327C the IMS signaling connection and the IMS service over SCG links of the first and the second split bearers, the UE 102 may use a configuration the UE 102 received prior to detecting 304C the MCG failure. For example, a previously-received configuration may enable the UE 102 to communicate IMS data and/or signaling messages via SCG links of the split bearers. In some implementations, to continue 327C the IMS signaling connection and the IMS service over SCG links of the first and the second split bearers, the UE 102 may use a configuration received after detecting 304C the MCG failure. For example, at 302C, the UE 102 may be configured to communicate IMS data and/or signaling messages only over MCG links of the first and the second split bearers. The MN 104, after determining that the UE 102 has detected an MCG failure, may reconfigure the UE 102 to communicate IMS data and/or signaling messages over SCG links of the first and the second split bearers, in a manner similar to the bearer configuration procedure 355A.

In some implementations, the UE 102 can transmit 327C the IMS signaling messages only over an SCG link of the first split bearer to the RAN 105, and/or transmits 327C the IMS media packets only over an SCG link of the second split bearer to one of the RAN 105, which can be similar as the description above. The RAN 105 can forward the IMS signaling messages and/or the IMS media packets to a CN 110, which can be similar to the description above. Then the CN 110 in turn forwards the IMS signaling messages and/or the IMS media packets to the IMS network 170.

If the first split bearer is an MN-terminated split bearer, the UE 102 can transmit 327C IMS signaling messages (e.g., SIP messages) over an SCG link of the first split bearer to the MN 104. If the second split bearer is an MN-terminated split bearer, the UE 102 can transmit 327C IMS media packets (e.g., RTP packets) over an SCG link of the second split bearer to the MN 104. If the first split bearer is an SN-terminated split bearer, the UE 102 in DC can transmit 327C IMS signaling messages (e.g., SIP messages) over an SCG link of the first split bearer to the SN 106A. If the second split bearer is an SN-terminated split bearer, the UE 102 in DC can transmit 342C IMS media packets (e.g., RTP packets) over an SCG link of the second split bearer to the SN 106A.

The IMS network 170 can send IMS signaling messages (e.g., SIP messages) and/or IMS media packets (e.g., RTP packets) to the CN 110, which in turn forwards the IMS signaling messages and/or the IMS media packets to the MN 104 or the SN 106A. Then the MN 104 or the SN 106A transmits 327C the IMS signaling messages and/or the IMS media packets over an SCG link of the first split bearer and/or an SCG link of the second split bearer to the UE 102, respectively.

In some implementations, the MN 104 can forward the IMS signaling messages and/or the IMS media packets to the SN 106A which in turn transmits 327C the IMS signaling messages and/or the IMS media packets over an SCG link of the first split bearer and/or an SCG link of the second split bearer respectively to the UE 102. The MN 104 may do so if the first split bearer is an SN-terminated split bearer and/or the second split bearer is an SN-terminated split bearer. In other implementations, the SN 106A can forward the IMS signaling messages and/or the IMS media packets to the MN 104 which in turn transmits 327C the IMS signaling messages and/or the IMS media packets over an SCG link of the first split bearer and/or an SCG link of the second split bearer respectively to the UE 102. The SN 106A may do so if the first split bearer is an MN-terminated split bearer and/or the second split bearer is an MN-terminated split bearer.

After the UE 102 recovers the MCG failure by the MCG failure recovery procedure 328C, the UE in DC with the MN 104 and the SN 106A can continue 332C the IMS signaling connection and the IMS service over the first split bearer and the second split bearer, respectively, as described for event 342C.

In some implementations, the UE 102 transmits 342C IMS signaling messages only over an MCG link of the first split bearer to the MN 104 or SN 106A and the UE 102 transmits 327C the IMS signaling messages only over an SCG link of the first split bearer to the MN 104. In other implementations, the UE 102 transmits 342C IMS media packets only over an MCG link of the first split bearer to the MN 104 or SN 106A and the UE 102 transmits 327C IMS media packets only over an SCG link of the first split bearer to the MN 104.

In some implementations, the UE 102 may mandatorily support IMS service over split bearer. In such implementations, the UE capability may not include a field indicating the UE 102 supports IMS service over a split bearer. For example, the UE 102 may mandatorily support IMS voice (or other IMS service) over a split bearer for EN-DC, NGEN-DC, NR-DC and/or NE-DC. and/or may mandatorily support an IMS signaling connection over a split bearer for EN-DC, NGEN-DC, NR-DC and/or NE-DC.

In other implementations, the UE capability of the UE 102 can indicate that the UE 102 supports an IMS service over a split bearer, e.g., for EN-DC, NGEN-DC, NR-DC and/or NE-DC. For example, the UE capability can indicate that the UE 102 supports an IMS signaling connection over a split bearer. Thus, the MN 104 or the SN 106A can determine to configure the first split bearer for the IMS signaling connection because the UE capability indicates that the UE 102 supports IMS signaling connection over a split bearer, e.g., at event 342C. In another example, the UE capability can indicate that the UE 102 supports an IMS service over a split bearer. Thus, the MN 104 or the SN 106A can determine to configure the second split bearer for the IMS service because the UE capability indicates that the UE 102 supports the IMS service over a split bearer, e.g., at event 342C.

In some implementations, the MN 104 may determine to configure the first split bearer for the IMS signaling connection because the UE capability indicates that the UE 102 supports an IMS service over a split bearer. In other implementations, the MN 104 may determine to configure the first split bearer for the IMS signaling connection in response to the MCG failure, irrespective of whether the UE capability indicates that the UE 102 supports the IMS service over a split bearer.

Referring next to FIG. 3D, a scenario 300D involves MCG failure during an IMS connection similar to the scenario 300B. In scenario 300D, the base station 104 operates as an MN and the base station 106A operates as an SN. As mentioned above, events in the scenario 300D similar to those discussed above with respect to the scenario 300C and 300B are labeled with similar reference numbers (e.g., with event 342D of FIG. 3D corresponding to event 342C of FIG. 3C and with event 330D of FIG. 3D corresponding to event 330B). With the exception of the differences shown in FIG. 3D and the differences described below, any of the alternative implementations discussed above with respect to the scenarios 300B and 300C (e.g., for messaging and processing) may apply to the scenario 300D.

Initially, the UE 102 operates 342D in DC with the MN 104 (via cell 124) and the SN 106A (via cell 126A) has an IMS signaling connection with an IMS network 170 over a first split bearer. After the UE 102 detects 304D an MCG failure, the UE continues 327D the IMS signaling connection over an SCG link of the first split bearer via RAN 105 (i.e., the MN 104, the SN 106A, or the SN 106A and the MN 104), and the CN 110 with the IMS network 170. Different from events 342C and 327C, the UE 102 does not have an IMS service or a second split bearer for an IMS service at events 342D and 327D.

To continue 327D the IMS signaling connection over the SCG link of the first split bearer, the UE 102 may use a configuration the UE 102 received prior to detecting 304D the MCG failure. For example, a previously-received configuration may enable the UE 102 to communicate IMS signaling messages via an SCG link of the first split bearer. In some implementations, to continue 327D the IMS signaling connection over the SCG link of the first split bearer, the UE 102 may use a configuration received after detecting 304D the MCG failure. For example, at 302D, the UE 102 may be configured to communicate IMS signaling messages only over an MCG link of the first split bearer. The MN 104, after determining that the UE 102 has detected an MCG failure, may reconfigure the UE 102 to communicate IMS signaling messages over the SCG link of the first split bearer, in a manner similar to the bearer configuration procedure 355B.

While the UE 102 continues 327D the IMS signaling connection over an SCG link of the first split bearer via the RAN 105 and the CN 110 with the IMS network 170, the UE 102 can initiate 330D a mobile originating (MO) IMS service via the IMS signaling connection over the SCG link of the first split bearer via the RAN 105 and the CN 110 with the IMS network 170. The UE 102 exchanges (i.e. sends and receives) IMS signaling messages (e.g., SIP messages) over the IMS signaling connection with the IMS network 170 to perform the MO IMS service.

Additionally or alternatively, while the UE 102 continues 327D the IMS signaling connection over an SCG link of the first split bearer via the RAN 105 and the CN 110 with the IMS network 170, the IMS network 170 can initiate 330D a MT IMS service via the IMS signaling connection over the SCG link of the first split bearer via the RAN 105 and the CN 110 with the UE 102. The IMS network 170 exchanges (i.e. sends and receives) IMS signaling messages (e.g., SIP messages) over the IMS signaling connection with the UE 102 to perform the MT IMS service.

In some implementations, the MO or MT IMS service can be an IMS short message service, an IMS supplementary service, an IMS USSD service, an IMS value added service, an IMS voice call, or an IMS video call.

In some implementations, the CN 110 can send a first RAN-CN interface message to request that the RAN 105 set up a radio bearer or a QoS flow for the IMS service after event 330D. In one implementation, the RAN 105 configures a radio bearer (i.e., an SCG bearer or MCG bearer) or QoS flow over the radio bearer for the IMS service for the UE 102 in response to the first RAN-CN interface message as described for FIG. 3B. In another implementation, the RAN 105 configures a split bearer or a QoS flow over the split bearer for the IMS service for the UE 102 in response to the first RAN-CN interface message. Thus, the UE 102 can communicate IMS media packets over an SCG link of the second split bearer with the RAN 105 as described for FIG. 3C.

In some implementations, the RAN 105 can transmit to the UE 102 a first RRC reconfiguration message to configure for the UE 102 the first split bearer or a first QoS flow over the first split bearer for the IMS signaling connection at event 342D. In response, the UE 102 can transmit a first RRC reconfiguration complete message to the RAN 105. The first QoS flow can be associated with a first QoS setting including multiple QoS parameters. The CN 110 can provide the first QoS setting to the RAN 105 in a second RAN-CN interface message similar to the first RAN-CN interface message. While the MCG failure is not occurring or after the MCG failure has been recovered, the UE 102 and the RAN 105 or the CN 110 can exchange IMS signaling messages over the first QoS flow on the first split bearer (e.g., using MCG only radio resources, SCG only radio resources, or both MCG and SCG radio resources). During the MCG failure, the UE 102 and the RAN 105 or the CN 110 can exchange IMS signaling messages over the first QoS flow on the first split bearer on an SCG link of the first split bearer. The UE 102, the RAN 105 and/or the CN 110 enforces the first QoS settings for IMS signaling messages exchanged over the first QoS flow.

In some implementations, the RAN 105 can configure the UE 102 a second QoS flow for the IMS service in response to the first RAN-CN interface message. The second QoS flow can be associated with a second QoS setting including multiple QoS parameters, and the second QoS setting may be different from the first QoS setting. The CN 110 can provide the second QoS settings to the RAN 105 in the first RAN-CN interface message. The UE 102 and the RAN 105 or the CN 110 can exchange IMS media packets over the second QoS flow with one another.

In some implementations, the RAN 105 configures the IMS service over the first split bearer (i.e., the IMS signaling connection and the IMS service are multiplexed on the first SCG bearer) in response to the first RAN-CN interface message. More specifically, the RAN 105 can perform a bearer configuration procedure (e.g., similar to the bearer configuration procedure 355B) to configure the first split bearer for the IMS service or the second QoS flow over the first split bearer. In the bearer configuration procedure, the RAN 105 can transmit an RRC container message (e.g., like event 318B) configuring the first split bearer for the IMS service or the second QoS flow over the first split bearer so that the UE 102 can configure the second QoS flow over the first split bearer in response to the RRC container message. The RAN 105 may or may not generate an SN configuration for the UE 102 in the bearer configuration procedure. In the RRC container message, the RAN 105 can include a radio bearer configuration configuring the IMS service or the second QoS flow over the first split bearer.

In other implementations, if the RAN 105 receives the first RAN-CN interface message from the CN 110 before the MCG failure is recovered by the MCG failure recovery procedure, the RAN 105 can perform a bearer configuration procedure (e.g., similar to the bearer configuration procedure 355B) to configure for the UE 102 a second split bearer for the IMS service or the second QoS flow over the second split bearer in response to the first RAN-CN interface message. After setting up the second split bearer as configured by the RAN 105, the UE 102 transmits IMS media packets over the second split bearer to the RAN 105, which forwards the IMS media packets to the CN 110. Then the CN 110 forwards the IMS media packets to the IMS network 170. In one implementation, the UE 102 transmits IMS media packets over the second split bearer to the SN 106A, which forwards the IMS media packets to the CN 110. In another implementation, the UE 102 transmits IMS media packets over the second split bearer to the SN 106A, which forwards the IMS media packets to the MN 104. Then the MN 104 forwards the IMS media packets to the CN 110, which in turn forwards the IMS media packets to the IMS network 170. Similarly, after configuring the second split bearer, the UE 102 receives IMS media packets over the second split bearer from the RAN 105, which receives the IMS media packets from the CN 110. The CN 110 receives the IMS media packets from the IMS network 170. In one implementation, the CN 110 sends the IMS media packets to the SN 106A which in turn transmits the IMS media packets over the second split bearer to the UE 102. In another implementation, the CN 110 sends the IMS media packets to the MN 104 which in turn forwards the IMS media packets to the SN 106A. Then the SN 106A transmits the IMS media packets to the UE 102 via the second split bearer.

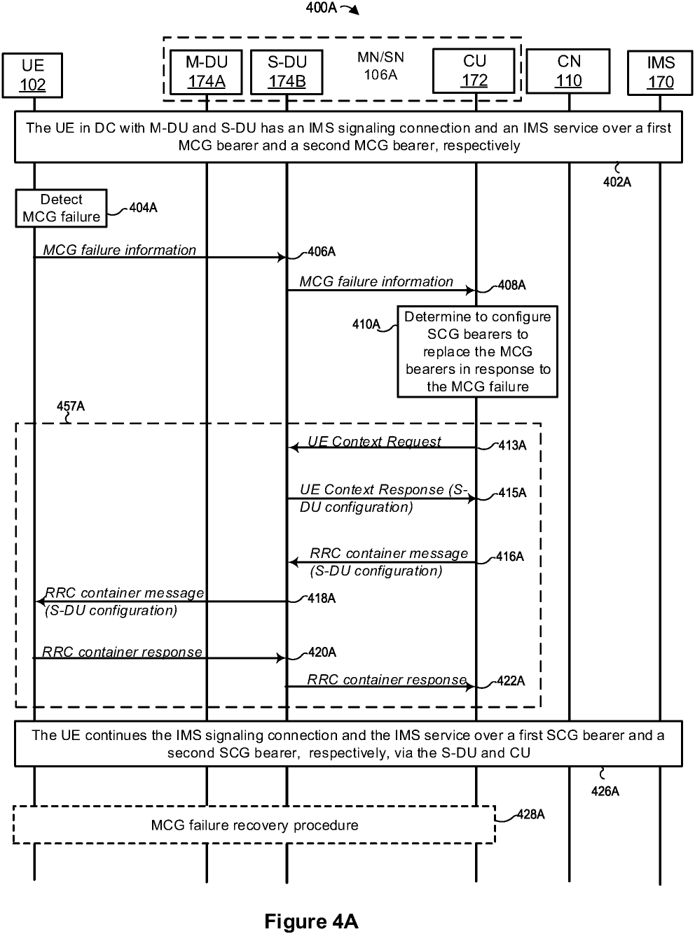

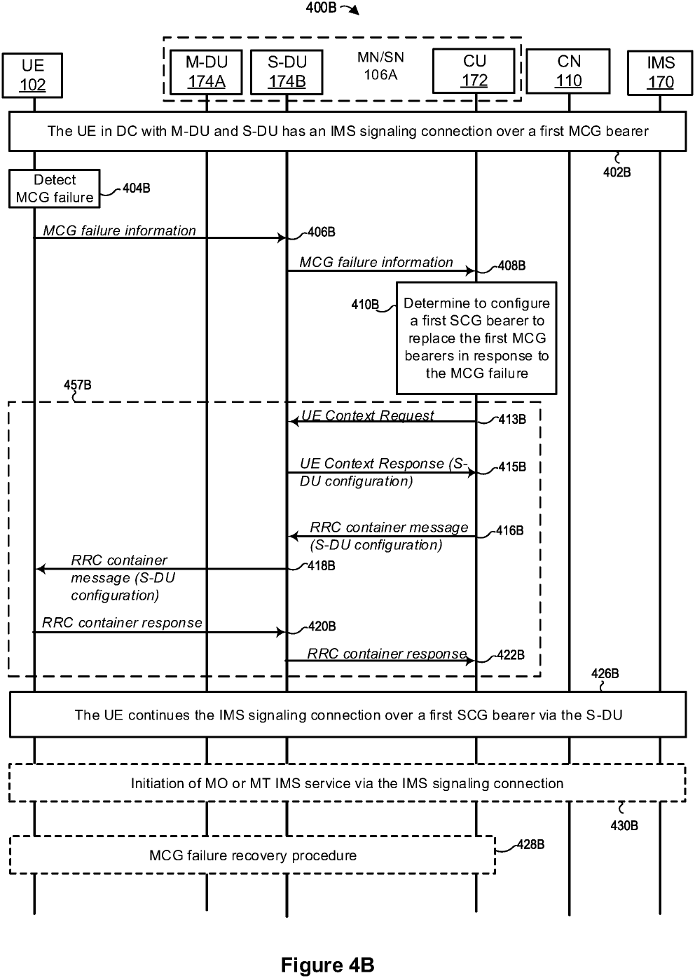

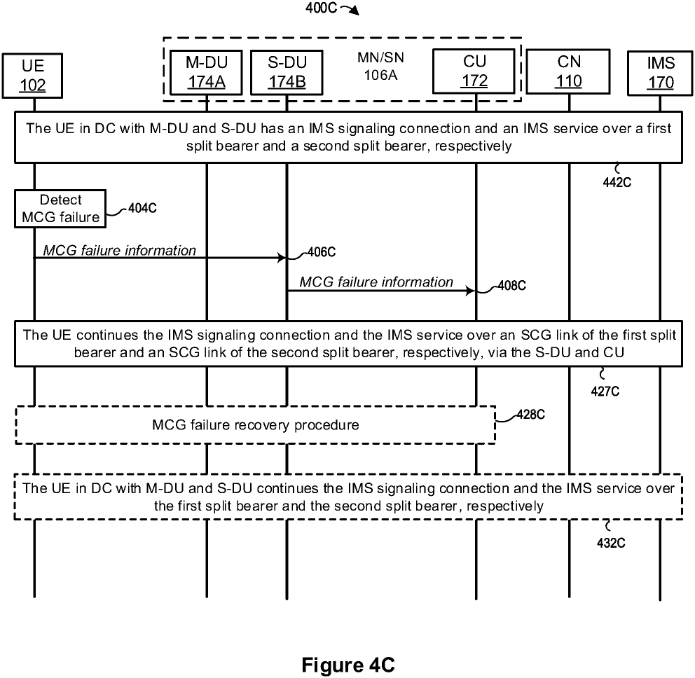

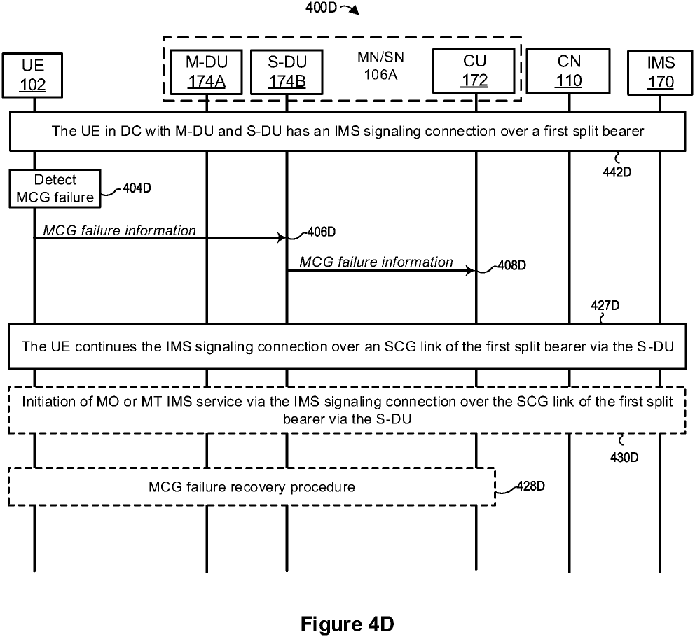

FIGS. 4A-4D are example message sequences similar to FIGS. 3A-3D, but where the base station 106A includes both CU 172, and two DUs that operate as a master DU (M-DU) 174A and a secondary DU (S-DU) 174B. The MN 106A consists of the CU 172 and the M-DU 174A and the description for the MN 104 or RAN 105 in FIGS. 3A-3D can apply to the CU 172 and/or the M-DU 174A. The SN 106A consists of the CU 172 and the S-DU 174B and the description for the SN 106A or RAN 105 in FIGS. 3A-3D can apply to the CU 172 and/or the S-DU 174B. Said another way, the CU 172 and the M-DU 174A of the base station 106A may collectively operate as the MN, and the CU 172 and the S-DU 174B of the base station 106A may collectively operate as the SN. Accordingly, events in the scenarios depicted in FIGS. 4A-4D and similar to those discussed with respect to FIGS. 3A-3D are labeled with similar reference numbers (e.g., with event 402A being similar to event 302A, 402B being similar to event 302B, etc.). With the exception of the differences shown in the figures and the differences described below, any of the alternative implementations discussed above with respect to the scenarios 300A-D (e.g., for messaging and processing) may apply to the scenarios 400A-D, respectively.

Referring first to FIG. 4A, a scenario 400A involves MCG failure during an IMS connection similar to the scenario 300A. In scenario 400A, base station 106A serves as an MN and SN for the UE 102 and includes the CU 172, the M-DU 174A, and the S-DU 174B.

Initially, the UE 102 operates 402A in DC with the M-DU 174A (via cell 128A) and the S-DU 174B (via cell 126A) and has an IMS signaling connection and an IMS service with an IMS network 170 over a first MCG bearer and a second MCG bearer, respectively. The UE 102 exchanges 402A messages and/or packets (e.g., RRC messages, IMS signaling messages and/or IMS media packets) with the CU 172 via the M-DU 174A in a way similar to that the UE 102 exchanges messages and/or packets (e.g., RRC messages, IMS signaling messages and/or IMS media packets) with the with the MN 104 at event 302A in FIG. 3A.

Later in time, the UE 102 detects 404A an MCG failure. In response to the detection 404A, the UE 102 can suspend MCG transmissions (i.e., suspend transmissions on all of MCG link(s) with the MN 104) and transmit 406A an MCG failure information message to the S-DU 174B, which in turn sends 408A the MCG failure information message to the CU 172. During the MCG failure, the UE 102 exchanges messages and/or packets (e.g., RRC messages, IMS signaling messages, and/or IMS media packets) with the CU 172 via the S-DU 174B in a way similar to that the UE 102 exchanges messages and/or packets (e.g., RRC messages, IMS signaling messages, and/or IMS media packets) with the SN 106A in FIG. 3A.

In some implementations, the CU 172 can determine that an MCG failure has occurred at the UE 102 in response to receiving the MCG failure information message. In other implementations, the CU 172 or the M-DU 174A determines that the MCG failure has occurred in response to not receiving a PDU or control signal(s) from the UE 102. For example, the PDU can be a MAC, RLC or PDCP PDU. In another example, the PDU can include an RRC message. The UE 102 can transmit the control signal(s) on control channel(s) which can be, for example, physical uplink control channel(s) (PUCCH(s)). In yet other implementations, the M-DU 174A determines that an MCG failure occurred at the UE 102 in response to receiving channel state information from the UE 102 that indicates invalid values or that downlink channel quality is bad. The M-DU 174A can send a DU-CU interface message to inform the CU 172 of the MCG failure. The DU-CU interface message can be a F1 application protocol (F1AP) message.

In response to the CU 172 determining that the MCG failure occurred, the CU 172 determines 410A to configure a first SCG bearer and a second SCG bearer to replace the first MCG bearer and the second MCG bearer, respectively. In response to the determination 410A, the CU 172 sends 413A a UE Context Request message (e.g., a UE Context Modification Request or UE Context Setup Request message) to the S-DU 174B. In response, the S-DU 174B generates a S-DU configuration for configuring the first SCG bearer and the second SCG bearer and sends 415A a UE Context Response message (e.g., a UE Context Modification Response or UE Context Setup Response message) including the S-DU configuration to the CU 172. Then the CU 172 sends 416A an RRC container message including the S-DU configuration to S-DU 174B, which in turn transmits 418A the RRC container message to the UE 102. In response, the UE 102 transmits 420A an RRC container response message to the S-DU 174B, which in turn sends 422A the RRC container message to the CU 172. The S-DU configuration includes multiple configuration parameters similar to the SN configuration. In some implementations, the UE 102 can include an RRC reconfiguration complete message in the RRC container response message. The events 413A, 415A, 416A, 418A, 420A and 422A are collectively referred to in FIG. 4A as a bearer configuration procedure 457A.

After receiving the RRC container message, the UE 102 configures the first SCG bearer and the second SCG bearer in accordance with the RRC container message or the S-DU configuration. The UE 102 continues 426A the IMS signaling connection and the IMS service over the first SCG bearer and the second SCG bearer, respectively, via the S-DU 174B, the CU 172 and the CN 110 with the IMS network 170. Thus, the UE 102 can communicate IMS media packets over the second SCG bearer with the CU 172 via the S-DU 174B. In some implementations, the UE 102 transmits 426A IMS signaling messages (e.g., SIP messages) over the first SCG bearer or transmits IMS media packets (e.g., RTP packets) over the second SCG bearer to the CU 172 over the S-DU 174B. The CU 172 forwards the IMS signaling messages or the IMS media packets to the CN 110 via a RAN-CN interface between the CU 172 and the CN 110 (e.g., S1 or NG interface). Then, the CN 110 in turn forwards the IMS signaling messages or the IMS media packets to the IMS network 170.

Similarly, the IMS network 170 can IMS signaling messages (e.g., SIP messages) or IMS media packets (e.g., RTP packets) to the CN 110, which in turn forwards the IMS signaling messages or the IMS media packets to the CU 172 via the RAN-CN interface. Then the CU 172 transmits 426A the IMS signaling messages over the first SCG bearer or the IMS media packets over the second SCG bearer to the UE 102.

Later in time, the CU 172 can perform 428A an MCG failure recovery procedure with the UE 102 to recover the MCG failure. To perform the MCG failure recovery procedure, the CU 172 can send a handover command message to the S-DU 174B which in turn transmits the handover command message to the UE 102, in some implementations. The handover command message can include multiple configuration parameters and indicate a target cell to which the UE 102 is to hand over and the UE 102 can attempt to hand over to the target cell in response to the handover command message. The target cell can be operated by a target base station which can be the base station 106A (i.e., the M-DU 174A, the S-DU 174B or another DU), base station 104 or base station 106B. In one implementation, the CU 172 can obtain a target DU (T-DU) configuration including some of the multiple configuration parameters in a UE Context (Modification/Setup) procedure with the M-DU 174A, the S-DU 174B, or another DU like events 413A and 415A. In such implementations, the CU 172 includes the T-DU configuration in the handover command message.

In some implementations, the UE 102 can perform a random access procedure on the target cell to handover to the target base station according to the handover command message. The UE 102 transmits a handover complete message on the target cell to the base station during or after the random access procedure, e.g., without wrapping the handover complete message in another RRC message. The CU 172 can generate the handover command message, or receive the handover command message from the target base station directly (i.e., via a RAN interface between the CU 172 and the target base station) or via the CN 110 in a handover preparation procedure. If the IMS signaling connection or the IMS service still exists during the handover preparation procedure, the target base station can configure a third MCG bearer or a fourth MCG bearer replacing the first SCG bearer or the second SCG bearer, respectively, in the handover command message. After successfully completing the handover to the target base station on the target cell, the UE 102 can continue the IMS signaling connection and the IMS service over the third MCG bearer and the fourth MCG bearer, respectively, with target base station. The third MCG bearer can be the same as or different from the first MCG bearer. The fourth MCG bearer can be the same as or different from the second MCG bearer.

In some implementations, the CU 172 includes, in the RRC container message 416A, at least one radio bearer configuration (e.g., RadioBearerConfig IE(s)) for configuring the first SCG bearer and/or the second SCG bearer to replace the first MCG bearer and/or the second MCG bearer, or for reconfiguring the first MCG bearer and/or the second MCG bearer to be the first SCG bearer and/or the second SCG bearer. In other implementations, the CU 172 does not include a radio bearer configuration in the RRC container message 416A.

Referring next to FIG. 4B, a scenario 400B involves MCG failure during an IMS connection similar to the scenarios 400A and 300B. In scenario 400B, base station 106A serves as an MN and SN for the UE 102 and includes CU 172, M-DU 174A, and S-DU 174B. As mentioned above, events in the scenario 400B similar to those discussed above with respect to the scenarios 400A and 300B are labeled with similar reference numbers (e.g., with event 402B of FIG. 4B corresponding to event 402A of FIG. 4A and event 302B of FIG. 3B). With the exception of the differences shown in FIG. 4B and the differences described below, any of the alternative implementations discussed above with respect to the scenarios 400A and 300B (e.g., for messaging and processing) may apply to the scenario 400B. The events 412B, 413B, 415B, 416B, 418B, 420B and 422B are collectively referred to in FIG. 4B as a bearer configuration procedure 457B. The bearer configuration procedure 457B is similar to the bearer configuration procedure 457A, except that the bearer configuration procedure 457B does not involve a second MCG bearer or a second SCG bearer.

Different from FIG. 4A, the UE 102 does not have an IMS service and a second MCG bearer for an IMS service before event 430B. While the UE 102 continues 426B the IMS signaling connection over the first SCG bearer via the CU 172 and the CN 110 with the IMS network 170, the UE 102 can initiate 430B a MO IMS service via the IMS signaling connection over the first SCG bearer via the CU 172 and CN 110 with the IMS network 170. The UE 102 exchanges (i.e. sends and receives) IMS signaling messages (e.g., SIP messages) over the IMS signaling connection with the IMS network 170 to perform the MO IMS service.

Additionally or alternatively, while the UE 102 continues 426B the IMS signaling connection over the first SCG bearer via the CU 172 and the CN 110 with the IMS network 170, the IMS network 170 can initiate 430B a MT IMS service via the IMS signaling connection over the first SCG bearer via the CU 172 and the CN 110 with the UE 102. The IMS network 170 exchanges (i.e. sends and receives) IMS signaling messages (e.g., SIP messages) over the IMS signaling connection with the UE 102 to perform the MT IMS service.

In some implementations, the CN 110 can send a first RAN-CN interface message to request that the CU 172 set up a radio bearer or a QoS flow for the IMS service during or after event 430B. For example, the CN 110 may do so if the IMS service is an IMS voice service or an IMS video service. The CN 110 may not do so if the IMS service is neither an IMS voice or an IMS video service. The CU 172 configures a radio bearer (e.g., the first SCG bearer, a second SCG bearer or a second MCG bearer) or QoS flow over the radio bearer for the IMS service for the UE 102 in response to the first RAN-CN interface message. For example, the first RAN-CN interface message may be a NGAP message (e.g., PDU SESSION RESOURCE MODIFY REQUEST message) or a S1AP message (e.g., E-RAB SETUP REQUEST message).

In some implementations, the CU 172 can transmit to the UE 102 via the M-DU 174A or the S-DU 174B a first RRC reconfiguration message to configure the UE 102 the first MCG bearer or a first QoS flow over the first MCG bearer for the IMS signaling connection at event 402B. In response, the UE 102 can transmit a first RRC reconfiguration complete message to the CU 172 via the M-DU 174A or the S-DU 174B. The first QoS flow can be associated with a first QoS setting including multiple QoS parameters. The CN 110 can provide the first QoS setting to the CU 172 in a second RAN-CN interface message similar to the first RAN-CN interface message. The UE 102 and the CU 172 or the CN 110 can exchange IMS signaling messages over the first QoS flow over the first MCG bearer. The UE 102, the CU 172, and/or the CN 110 enforce the first QoS setting for IMS signaling messages exchanged over the first QoS flow.

In some implementations, the RAN 105 can configure the first QoS flow over the first SCG bearer for the UE 102 in the bearer configuration procedure 457B so that the UE 102 can configure the first QoS flow over the first SCG bearer in response to the RRC container message at event 418B. The UE 102 and the CU 172 or the CN 110 can exchange IMS signaling messages over the first QoS flow over the first SCG bearer. The UE 102, the CU 172 and/or the CN 110 enforce the first QoS setting for IMS signaling messages exchanged over the first QoS flow.

In some implementations, the CU 172 can configure the UE 102 a second QoS flow for the IMS service in response to the first RAN-CN interface message. The second QoS flow can be associated with a second QoS setting including multiple QoS parameters and different the first QoS setting. The CN 110 can provide the second QoS settings to the CU 172 in the first RAN-CN interface message. The UE 102 and the CU 172 or the CN 110 can exchange IMS media packets over the second QoS flow with one another.

In other implementations, if the CU 172 receives the first RAN-CN interface message from the CN 110 before the MCG failure is recovered by the MCG failure recovery procedure, the CU 172 can perform a bearer configuration procedure (e.g., similar to the bearer configuration procedure 457B) to configure the UE 102 a second SCG bearer for the IMS service or the second QoS flow over the second SCG bearer in response to the first RAN-CN interface message. After setting up the second SCG bearer or the second QoS flow over the second SCG bearer as configured by the CU 172, the UE 102 transmits IMS media packets over the second SCG bearer or the second QoS flow to the CU 172, which forwards the IMS media packets to the CN 110. The UE 102 transmits IMS media packets over the second SCG bearer or the second QoS flow via the S-DU 174B to the CU 172, which forwards the IMS media packets to the CN 110. Then the CU 172 forwards the IMS media packets to the CN 110, which in turn forwards the IMS media packets to the IMS network 170. Similarly, after configuring the second SCG bearer or the second QoS flow, the UE 102 receives IMS media packets over the second SCG bearer or the second QoS flow from the CU 172, which receives the IMS media packets from the CN 110 via the first RAN-CN interface. The CN 110 receives the IMS media packets from the IMS network 170. The first and second SCG bearers can be the same or different bearers.

In other implementations, if the CU 172 receives the first RAN-CN interface message from the CN 110 while the CU 172 is preparing the MCG failure recovery procedure (e.g., a handover procedure), the CU 172 can transmit a handover command message configuring a second MCG bearer or the second QoS flow over the second MCG bearer to the UE 102 in the MCG failure recovery procedure. In some of these implementations, the CU 172 includes configuration parameters configuring the second MCG bearer or the second QoS flow in the handover command message. In one implementation, the CU 172 can obtain a target DU (T-DU) configuration including some of the configuration parameters in a UE Context Modification procedure with the M-DU 174A or the S-DU 174B (e.g., events 413B and 415B). In another implementation, the CU 172 can obtain a T-DU configuration including some of the configuration parameters in a UE Context Setup procedure with a target DU (e.g., the S-DU 174B or another DU). In the UE Context Setup procedure, the CU 172 sends a UE Context Setup Request message to the target DU and in response receives a UE Context Setup Response message including the T-DU configuration from the target DU. In such implementations, the CU 172 includes the T-DU configuration in the handover command message. In other implementations, the CU 172 prepares the handover procedure with a target base station for the UE 102 and the target base station includes configuration parameters configuring the second MCG bearer or the second QoS flow over the second MCG bearer in the handover command message, which can be similar to events 512, 514, 516, 518, 520 and 522, discussed below with reference to FIG. 5. The configuration parameters may include a radio bearer configuration (e.g., a RadioBearerConfig IE or a DRB-ToAddMod) and/or an RLC configuration (e.g., an RLC-BearerConfig IE or RLC-Config IE). The first and second MCG bearers can be the same or different bearers.

In yet other implementations, if the CU 172 receives the first RAN-CN interface message from the CN 110 after the MCG failure is recovered by the MCG failure recovery procedure at event 428B, the CU 172 can transmit to the UE 102 an RRC reconfiguration message configuring a second MCG bearer for the IMS service or the second QoS flow over the second MCG bearer via an SRB (e.g., SRB1). In response, the UE 102 can transmit an RRC reconfiguration complete message to the MN via on the SRB. The UE 102 and the CU 172 can exchange the RRC reconfiguration message and the RRC reconfiguration complete message via MCG radio resources which can be provided by a M-DU (e.g., the M-DU 174A or a new M-DU) operated by the CU 172. The new M-DU can be the S-DU 174B or another DU. In one implementation, the CU 172 includes configuration parameters configuring the second MCG bearer or the second QoS flow over the second MCG bearer in the RRC reconfiguration message. After configuring the second MCG bearer or the second QoS flow over the second MCG bearer, the UE 102 transmits IMS media packets over the second MCG bearer or the second QoS flow via the M-DU to the CU 172, which forwards the IMS media packets to the CN 110. The CN 110 forwards the IMS media packets to the IMS network 170. Similarly, after configuring the second MCG bearer or the second QoS flow, the UE 102 receives IMS media packets over the second MCG bearer or the second QoS flow via the M-DU from the CU 172, which receives the IMS media packets from the CN 110. The CN 110 receives the IMS media packets from the IMS network 170. The configuration parameters include a radio bearer configuration (e.g., a RadioBearerConfig IE or a DRB-ToAddMod) and/or an RLC configuration (e.g., an RLC-BearerConfig IE or RLC-Config IE). The first and second MCG bearers can be the same or different bearers.

In yet other implementations, if the CU 172 receives the first RAN-CN interface message from the CN 110 during the MCG failure, the CU 172 may reject setting up a radio bearer for the UE 102.

Referring next to FIG. 4C, a scenario 400C involves MCG failure during an IMS connection similar to the scenarios 400A and 300C. In scenario 400C, base station 106A serves as an MN and SN for the UE 102 and includes CU 172, M-DU 174A and S-DU 174B. As mentioned above, events in the scenario 400C similar to those discussed above with respect to the scenarios 400A and 300C are labeled with similar reference numbers (e.g., with event 442C of FIG. 4C corresponding to event 342C of FIG. 3C and with event 404C of FIG. 4C corresponding to event 404A of FIG. 4A).

Referring next to FIG. 4D, a scenario 400D involves MCG failure during an IMS connection similar to the scenarios 400B, 400C and 300D. In scenario 400D, base station 106A serves as an MN and SN for the UE 102 and includes CU 172, M-DU 174A and S-DU 174B. As mentioned above, events in the scenario 400D similar to those discussed above with respect to the scenario 400B, 400C and 300D are labeled with similar reference numbers (e.g., with event 442C of FIG. 4C corresponding to event 342C of FIG. 3C and with event 430D of FIG. 4D corresponding to event 430B of FIG. 4B). Different from events 442C and 427C, the UE 102 does not have an IMS service and a second split bearer for an IMS service at events 442D and 427D.

FIGS. 5-7 illustrate message sequences in which a UE 102 detects an MCG failure occurs during an IMS signaling connection, and, in some scenarios, an IMS service, and the MN 104 can prepare a handover to the SN 106A or to a target base station to continue the IMS signaling connection and/or IMS service for the UE 102.

Turning to FIG. 5, the base station 104 in scenario 500 operates as an MN, and the base station 106A operates as an SN. Events 502, 504, 506 and 508 are similar to events 302A-D, 304A-D, 306A-D and 308A-D.

Initially, the UE 102 in DC with the MN 104 (via cell 124) and the SN 106A (via cell 126A) has 502 an IMS signaling connection with an IMS network 170 over a first MCG bearer. The UE 102 in DC may additionally have an IMS service with the IMS network 170 over a second MCG bearer. Later in time, the UE 102 determines 504 MCG failure. In response to the determination 504, the UE 102 transmit 506 an MCG failure information message to the SN 106A, which in turn sends 508 the MCG failure information message to the MN 104.

In some implementations, the UE 102 does not have an IMS service and a second MCG bearer for an IMS service before event 530. During the MCG failure, the UE 102 can continue the IMS signaling connection over the first split bearer as described for event 327D. While the UE 102 continues the IMS signaling connection over an SCG link of the first split bearer via the RAN 105 and the CN 110 with the IMS network 170, the UE 102 or the IMS network 170 can initiate 530 an MO or MT IMS service over the SCG link of the first split bearer with one another as described for event 330D. In some implementations, the MO or MT IMS service can be an IMS short message service, an IMS supplementary service, an IMS USSD service, an IMS value added service, an IMS voice call, or an IMS video call. In some implementations, the CN 110 can send a first RAN-CN interface message to request that the RAN 105 set up a radio bearer or a QoS flow for the IMS service during or after event 530, as described for FIG. 3D.

After receiving the MCG failure information message, the MN 104 determines 510 to hand over the UE 102 to the SN 106A to recover the MCG failure so that the UE 102 can continue the IMS signaling connection and the IMS service (if an IMS service is in progress) with the IMS network 170. In response to the determination 510, the MN 104 sends 512 a Handover Request message to the SN 106A. In response to the Handover Request message, the SN 106A generates a handover command message configuring a third MCG or split bearer for the IMS signaling connection and additionally a fourth MCG bearer for the IMS service (if an IMS service is in progress), and sends 514 a Handover Request Acknowledge message including the handover command to the MN 104. Then the MN 104 sends 516 the handover command message to the SN 106A, which in turn transmits 518 the handover command message to the UE 102. In response to the handover command message, the UE 102 can perform 520 a random access procedure with the SN 106A and transmits 522 a handover complete message to the SN 106A during or after the random access procedure. After the SN 106A receives the handover complete message, the SN 106A can send 524 a UE Context Release message to the MN 104 to notify the MN 104 that the MN 104 can release radio and/or control plane resources for the UE 102. In response to the UE Context Release message, the MN 104 releases radio and/or control plane resources for the UE 102.

After the UE 102 successfully completes the random access procedure at event 520 or transmits the handover complete message at event 522, the UE 102 continues 526 the IMS signaling connection over the third MCG or split bearer via the SN 106A (i.e., a new MN of the UE 102), and continues 526 the IMS service over the fourth MCG bearer via the SN if the UE 102 has the IMS service ongoing at event 502 or initiated at event 530.

In some implementations, the MN 104 can make the determination 510 in response to the MN 104 determining that the MCG failure occurred or in response to the MCG failure information message, as described above. In other implementations, the MN 104 can make the determination 510 in response to receiving the first RAN-CN interface message.

In some implementations, the MN 104 can determine 510 to hand over the UE 102 to a target base station (T-BS) (e.g., base station 106B) instead of the SN 106A. In such implementations, events 512, 514 and 524 can occur between the MN 104 and the T-BS and events 520, 522 and 526 can occur between the T-BS and the UE 102.

In some implementations, the MN 104 may send an SN Release Request message to the SN 106A. In response, the SN 106A may send an SN Release Request Acknowledge message to the MN 104. In other implementations, the MN 104 may not send an SN Release Request message. In yet other implementations, if the MN 104 determines to hand over the UE 102 to the SN 106A, the MN 104 does not send an SN Release Request message to the SN 106A. If the MN 104 determines to hand over the UE 102 to the T-BS, the MN 104 sends an SN Release Request message to the SN 106A.

In some implementations, the handover command message and the handover complete message can be an RRC reconfiguration message and an RRC reconfiguration complete message respectively as described above. The RRC reconfiguration message includes a mobility field (e.g., a mobilityControlInfo or reconfigurationWithSync field for PCell).

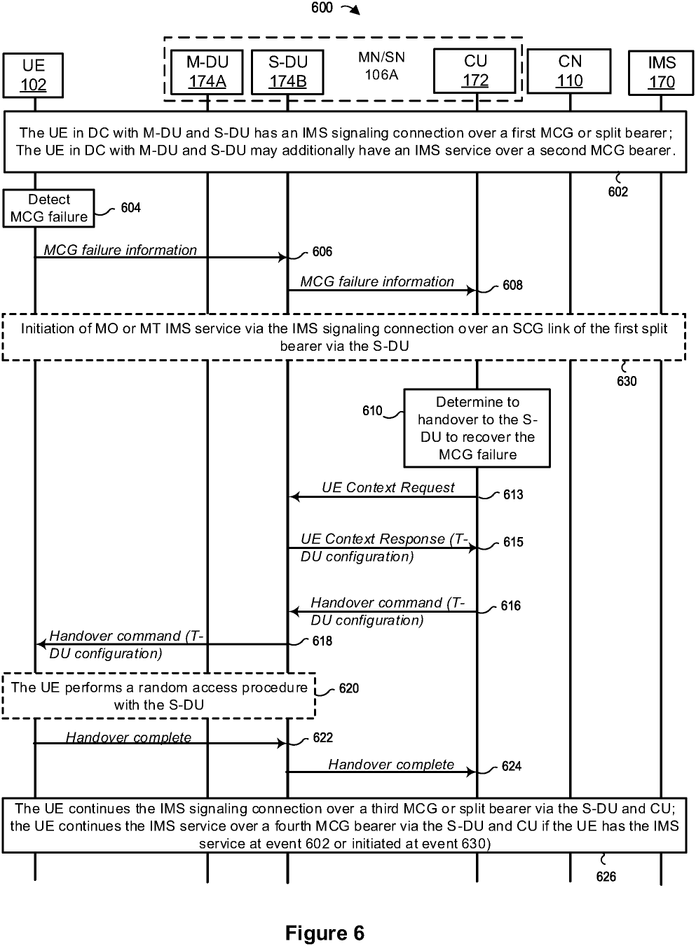

Referring next to FIG. 6, a scenario 600 involves MCG failure during an IMS connection similar to the scenarios 500, 400A and 400D. In scenario 600, base station 106A serves as an MN and SN for the UE 102 and includes CU 172, M-DU 174A and S-DU 174B. The MN 106A consists of the CU 172 and the M-DU 174A and the description for the MN 104 or RAN 105 in FIG. 5 can apply to the CU 172 and/or the M-DU 174A. The SN 106A consists of the CU 172 and the S-DU 174B and the description for the SN 106A or RAN 105 in FIGS. 5, 4A and 4D can apply to the CU 172 and/or the S-DU 174B. Accordingly, events in the scenarios depicted in FIG. 6 and similar to those discussed with respect to FIG. 5 are labeled with similar reference numbers (e.g., with event 602 being similar to event 502, 604 being similar to event 504, etc.). In addition, event 602 is similar to events 402A and 442D and event 630 is similar to event 430D. With the exception of the differences shown in the figures and the differences described below, any of the alternative implementations discussed above with respect to the scenario 500 (e.g., for messaging and processing) may apply to the scenario 600, respectively.

Initially, the UE 102 operates 602 in DC with the M-DU 174A (via cell 128A) and the S-DU 174B (via cell 126A) and has an IMS signaling connection and an IMS service with an IMS network 170 over a first MCG bearer and a second MCG bearer, respectively. Later in time, the UE 102 detects 604 an MCG failure. In response to the detection 604, the UE 102 transmits 606 an MCG failure information message to the S-DU 174B, which in turn sends 608 the MCG failure information message to the CU 172.

In some implementations, the UE 102 does not have an IMS service and a second MCG bearer for an IMS service before event 530. During the MCG failure, the UE 102 can continue the IMS signaling connection over the first split bearer as described for event 327D. While the UE 102 continues the IMS signaling connection over an SCG link of the first split bearer via the RAN 105 and the CN 110 with the IMS network 170, the UE 102 or the IMS network 170 can initiate 530 an MO or MT IMS service over the SCG link of the first split bearer with one another as described for event 330D. In some implementations, the MO or MT IMS service can be an IMS short message service, an IMS supplementary service, an IMS USSD, an IMS value added service, an IMS video call, or an IMS voice call. In some implementations, the CN 110 can send a first RAN-CN interface message to request that the RAN 105 set up a radio bearer or a QoS flow for the IMS service during or after event 530, as described for FIG. 3D.

After receiving the MCG failure information message, the CU 172 determines 610 to handover to the S-DU 174B to recover the MCG failure so that the UE 102 can continue the IMS signaling connection and the IMS service (if an IMS service is in progress) with the IMS network 170. In response to the determination 610, the CU 172 sends 613 a UE Context Request message (e.g., a UE Context Modification Request or UE Context Setup Request message) to the S-DU 174B. In response, the S-DU 174B generates a T-DU configuration and sends 615 a UE Context Response message (e.g., a UE Context Modification Response or UE Context Setup Response message) including the T-DU configuration to the CU 172. In response to the UE Context Request Response message, the CU 172 generates a handover command including the T-DU configuration for configuring the UE 102 to handover to the S-DU 174B. Then the MN 104 sends 616 the handover command message to S-DU 174B, which in turn transmits 618 the handover command message to the UE 102. In response to the handover command message, the UE 102 can perform 620 a random access procedure with the S-DU 174B and transmits 622 a handover complete message to the S-DU 174B during or after the random access procedure. The S-DU 174B in turn sends 624 the handover complete message to the CU 172. In some implementations, the CU 172 can send a UE Context Release Command message to the M-DU 174A to release a UE context of the UE 102 in the M-DU 174A. In response to the UE Context Release Command message, the M-DU 174A releases the UE context of the UE 102.

After the UE 102 successfully completes the random access procedure at event 620 or transmits the handover complete message at event 622, the UE 102 continues 626 the IMS signaling connection over the third MCG or split bearer via the S-DU 174B (i.e., a new M-DU of the UE 102) and CU 172, and continues 626 the IMS service over the fourth MCG bearer via the S-DU 174B and CU 172 if the UE 102 has the IMS service ongoing at event 602 or initiated at event 630.

In some implementations, the MN 104 can make the determination 610 in response to the MN 104 determining that the MCG failure occurred or in response to the MCG failure information message, as described above. In other implementations, the MN 104 can make the determination 610 in response to receiving the first RAN-CN interface message.

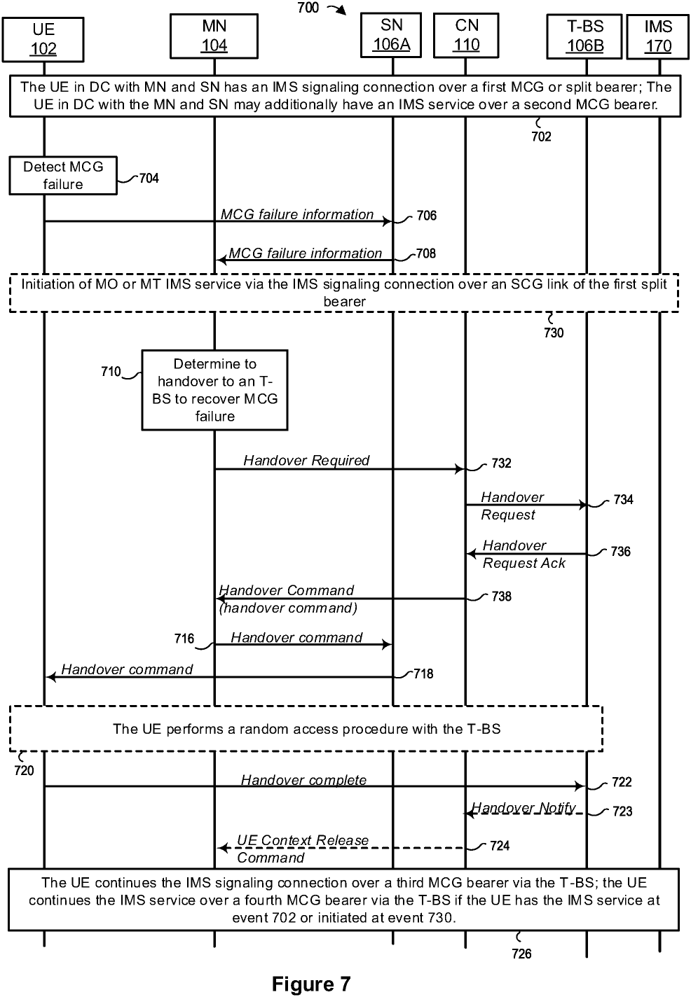

Referring now to FIG. 7, in which the base station 104 in scenario 700 operates as an MN, the base station 106A operates as an SN, and the base station 106B operates as a target base station (T-BS), which may operate using a radio access technology (RAT) different from the MN 104. Event 702, 704, 706, 708 and 730 are similar to events 502, 504, 506, 508 and 530.

After receiving the MCG failure information message, the MN 104 determines 710 to hand over the UE 102 to the T-BS 106B to recover the MCG failure so that the UE 102 can continue the IMS signaling connection and the IMS service (if an IMS service is in progress) with the IMS network 170. In response to the determination 710, the MN 104 sends 732 a Handover Required message to the CN 110. In response, the CN 110 sends 734 a Handover Request message to the T-BS 106B. In response to the Handover Request message, the T-BS 106B generates a handover command message configuring a third MCG or split bearer for the IMS signaling connection and additionally a fourth MCG bearer for the IMS service (if an IMS service is in progress), and sends 736 a Handover Request Acknowledge message including the handover command message to the CN 110. Alternatively, the T-BS 106B can generate a handover command message configuring a circuit-switched (CS) bearer (e.g., a CS radio access bearer) for turning the IMS service into a CS service.

Then the MN 104 sends 738 a Handover Command message including the handover command message to MN 104, which in turn transmits 716 the handover command message to the SN 106A. Finally, the SN 106A transmits the handover command message to the UE 102. In response to the handover command message, the UE 102 can perform 720 a random access procedure with the T-BS 106B on a cell of the T-BS 106B and transmits 722 a handover complete message to the T-BS 106B during or after the random access procedure. After receiving the handover complete message, the T-BS 106B can send 723 a Handover Notify message (or a similar message) to the CN 110 to notify the CN 110 that the UE 102 has successfully completed the handover to the T-BS 106B. In response to the Handover Notify message, the CN 110 can send 724 a UE Context Release Command message to the MN 104 to release of a connection between the MN 104 and the CN 110 (e.g., a logical NG connection or S1 connection). In response to the UE Context Release message, the MN 104 releases the connection and/or a UE context of the UE 102.

After the UE 102 successfully completes the random access procedure at event 720 or transmits the handover complete message at event 722, the UE 102 continues 726 the IMS signaling connection over the third MCG or split bearer via the SN 106A (i.e., a new MN of the UE 102) if the handover command message configures the third MCG or split bearer, and continues 726 the IMS service over the fourth MCG bearer via the SN if the UE 102 has the IMS service ongoing at event 702 or initiated at event 730 and the handover command message configures the fourth MCG bearer. Alternatively, if the handover command configures a CS bearer (e.g., a CS radio access bearer) for turning the IMS service into a CS service, the UE 102 turns the IMS service into the CS service. For example, if the IMS service is a voice call or a video call, the UE 102 continues the voice call or video call via the CS bearer.

In some implementations, the MN 104 can make the determination 710 in response to the MN 104 determining that the MCG failure occurred or in response to the MCG failure information message, as described above. In other implementations, the MN 104 can make the determination 710 in response to receiving the first RAN-CN interface message.

In some implementations, the handover command message and the handover complete message can be an RRC reconfiguration message and an RRC reconfiguration complete message, respectively, as described above. The RRC reconfiguration message includes a mobility field (e.g., a mobilityControlInfo or reconfigurationWithSync field for PCell). The Reconfiguration message can configure the third MCG or split bearer. In other implementations, the handover command message and handover complete message can be a Handover to UTRAN Command message and a Handover to UTRAN Complete message respectively as specified in 3GPP TS 25.331. The Handover to UTRAN Command message can configure the CS bearer. If the MN 104 and the T-BS 106B operate different RATs, the MN 104 includes the handover command message in an MN RRC container message (e.g., a MobilityFromNRCommand or MobilityFromEUTRACommand message).

In some implementations, the MN 104 can redirect the UE 102 to an inter-RAT carrier frequency and/or inter-RAT cell (i.e., a cell operated by a base station of a RAT different from a RAT of the MN) instead of determining to hand over the UE 102 at event 510, 610 or 710. The MN 104 can generate an RRC release message including frequency information and/or cell information indicating a carrier frequency and/or a cell and send the RRC release message (e.g., an RRCRelease message or RRCConnectionRelease message) to the UE 102 via the SN 106, which is similar to transmission of the RRC container message at events 320B and 322B. The UE 102 selects a (the) cell according to the frequency information and/or the cell information. For example, the frequency information includes a channel number such as absolute radio frequency channel number (ARFCN) and the cell information includes a (physical) cell identity. The carrier frequency can be an inter-RAT or intra-RAT carrier frequency, and the cell can be an inter-RAT or intra-RAT cell.

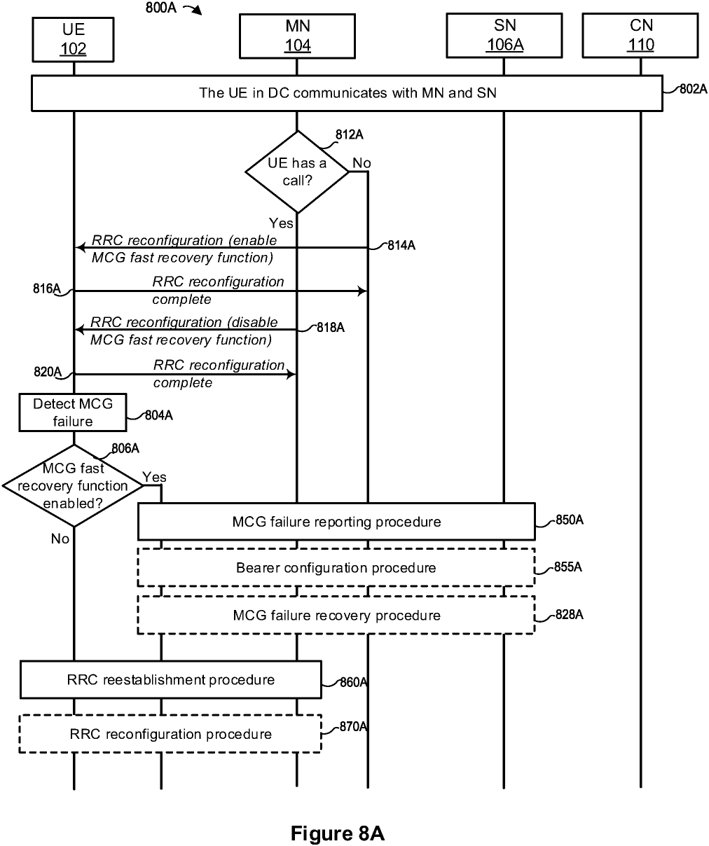

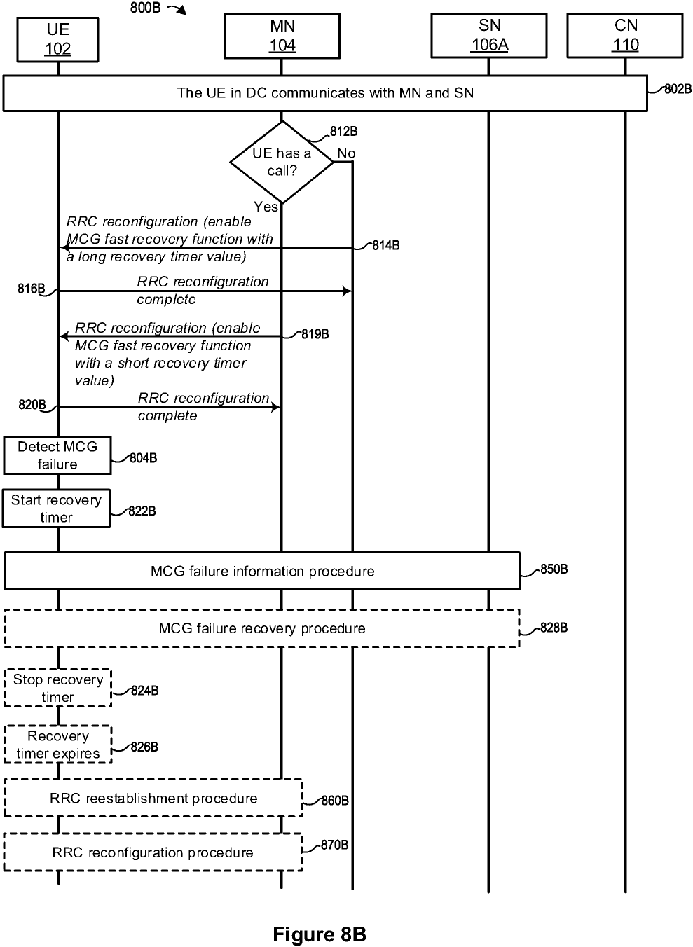

Referring next to FIG. 8A, the base station 104 in scenario 800A operates as an MN, and the base station 106A operates as an SN. Initially, the UE 102 in DC communicates 802A data (e.g., UL PDUs and/or DL PDUs) with the MN 104 (via cell 124) and the SN 106A (via cell 126A) on at least one data radio bearer (DRB), which can be an MCG bearer, an SCG bearer, or a split bearer.

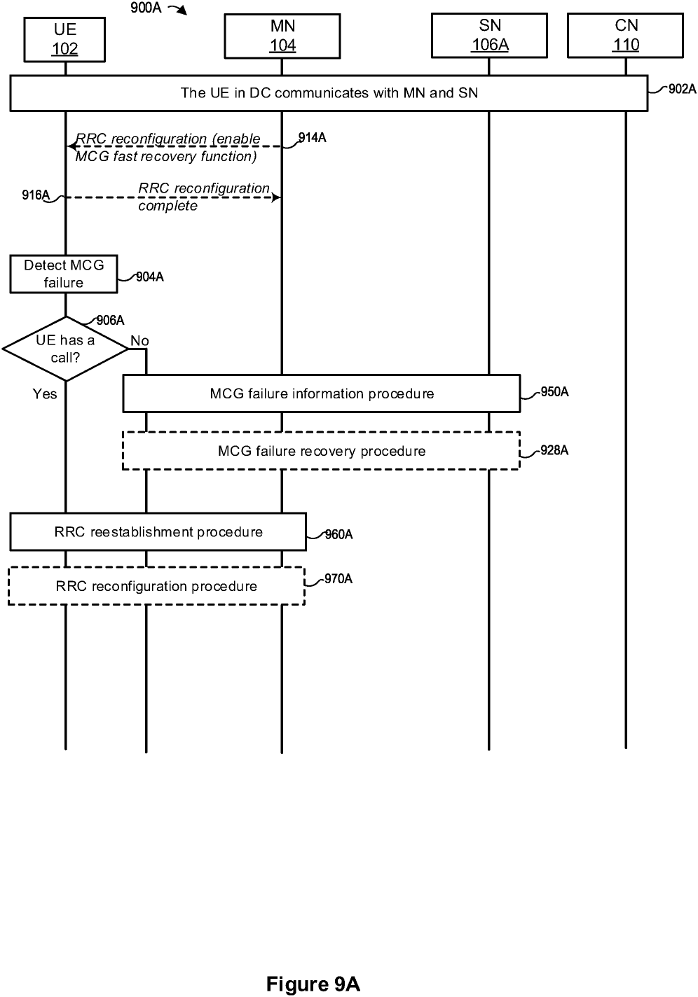

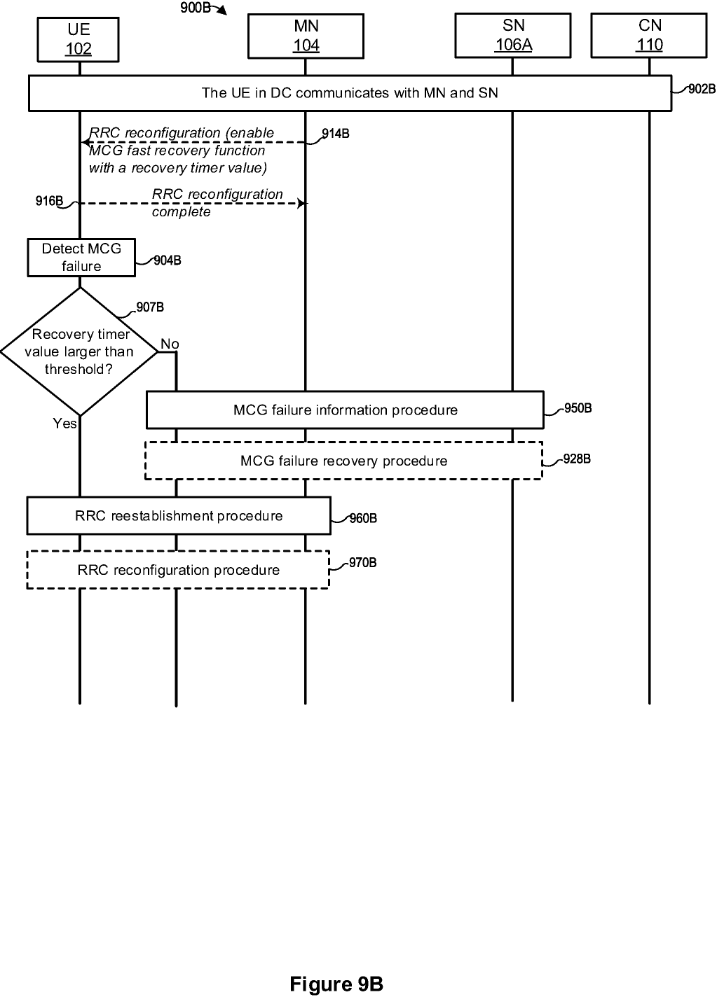

The MN 104 determines 812A whether the UE 102 in DC with the MN 104 and the SN 106A has a packet-based call ongoing (e.g., an IMS voice call or video call). If the UE 102 does not have a packet-based call, the MN 104 transmits 814A an RRC reconfiguration message enabling the MCG fast recovery function to the UE 102. While FIGS. 8A-9B refer to enabling the MCG fast recovery function, it should be understood that the MCG fast recovery function is an example MCG recovery procedure, and that the MCG fast recovery function could be, in other implementations, another MCG recovery procedure. In response, the UE 102 transmits 816A an RRC reconfiguration complete message to the MN 104. If the UE 102 has a voice call, the MN 104 transmits 818A an RRC reconfiguration message disabling (or not enabling) the MCG fast recovery function to the UE 102. In response, the UE 102 transmits 820A an RRC reconfiguration complete message to the MN 104.

Later in time, the UE 102 detects 804A an MCG failure, similar to event 304A. The UE 102 determines 806A whether the MCG fast recovery function is enabled. If the MCG fast recovery function is enabled, the UE 102 performs 850A an MCG failure reporting procedure with the SN 106A and the MN 104 in response to the determination 806A, similar to the MCG failure reporting procedure 350A. In response to the MN 104 determining that the MCG failure occurred due to the MCG failure reporting procedure, the MN 104 can perform 855A a bearer configuration procedure to reconfigure the DRB and/or 828A an MCG failure recovery procedure with the UE 102 via the SN 106A, similar to the bearer configuration procedure 355A, 355B, 355C, 355D and the MCG failure recovery procedure 328A, 328B, 328C, 328D respectively. If the MCG fast recovery function is disabled, the UE 102 performs 860A an RRC re-establishment procedure with the MN 104 in response to the detection 804A. The MN 104 can perform 870A an RRC reconfiguration procedure with the UE 102 while or after performing the RRC re-establishment procedure. Alternatively, the UE 102 performs an RRC re-establishment procedure with a new MN (e.g., the SN 106A or base station 106B) instead of the MN 104 in response to the determination 804A and the new MN can perform an RRC reconfiguration procedure with the UE 102 while or after performing the RRC re-establishment procedure.

In some implementations, the UE 102 can transmit an RRC(Connection)ReestablishmentRequest message to a base station (i.e., the MN 104 or the base station 106B). The base station transmits an RRC(Connection)Reestablishment message to the UE 102 in response to the RRC RRC(Connection)ReestablishmentRequest message. The UE 102 can transmit an RRC(Connection)ReestablishmentComplete message to the base station in response to the RRC(Connection)Reestablishment message. After receiving the RRC(Connection)Reestablishment or RRC(Connection)ReestablishmentComplete message, the base station can transmit an RRC(Connection)Reconfiguration message to the UE 102 to perform the RRC reconfiguration procedure with the UE 102. In response, the UE 102 can transmit an RRC(Connection)ReconfigurationComplete message to the base station.

Referring next to FIG. 8B, the base station 104 in scenario 800B operates as an MN, and the base station 106A operates as an SN. As mentioned above, events in the scenario 800B similar to those discussed above with respect to the scenario 800A are labeled with similar reference numbers (e.g., with event 802A of FIG. 8A corresponding to event 802B of FIG. 8B). With the exception of the differences shown in FIG. 8B and the differences described below, any of the alternative implementations discussed above with respect to the scenario 800A (e.g., for messaging and processing) may apply to the scenario 800B.

If the UE 102 does not have a packet-based call (e.g., an IMS voice or video call), the MN 104 transmits 814B an RRC reconfiguration message enabling the MCG fast recovery function with a long recovery timer value (e.g., a long timer T316 value) to the UE 102. In response, the UE 102 transmits 816B an RRC reconfiguration complete message to the MN 104. If the UE 102 has a packet-based call, the MN 104 transmits 819B an RRC reconfiguration message enabling the MCG fast recovery function with a short recovery timer value (e.g., a short timer T316 value) to the UE 102. In response, the UE 102 transmits 820B an RRC reconfiguration complete message to the MN 104.

Later in time, the UE 102 determines 804B MCG failure, similar to event 304A. The UE 102 can start 822B a recovery timer (e.g., T316) with either the long recovery timer value or the short recovery timer value in response to the determination 804B. The UE 102 performs 850B an MCG failure reporting procedure with the SN 106A and the MN 104 in response to the determination 804B, similar to the MCG failure reporting procedure 350A. Alternatively, the UE 102 can start 822B the recovery timer with either the long recovery timer value or the short recovery timer value in response to the MCG failure reporting procedure. In response to the MN 104 determining the MCG failure from the MCG failure reporting procedure, the MN 104 can perform 828B an MCG failure recovery procedure with the UE 102 via the SN 106A, similar to the MCG failure recovery procedure 328A, 328B, 328C, 328D respectively. While not depicted in FIG. 8B, the MN 104 can perform a bearer configuration procedure, similar to the bearer configuration procedure 355A, 355B, 355C, and 355D, prior to performing 828B the MCG failure recovery procedure with the UE 102, similar to FIG. 8A. If the UE 102 successfully recovers the MCG failure in the MCG failure recovery procedure, the UE 102 stops 824B the recovery timer. Otherwise, the recovery timer expires 826B. In response to expiry of the recovery timer, the UE 102 can perform 860B an RRC re-establishment procedure and 870B an RRC reconfiguration procedure with the MN 104, the SN 106A or base station 106B.

Referring next to FIG. 9A, the base station 104 in scenario 900A operates as an MN, and the base station 106A operates as an SN. As mentioned above, events in the scenario 900A similar to those discussed above with respect to the scenario 800A are labeled with similar reference numbers (e.g., with event 802A of FIG. 8A corresponding to event 902A of FIG. 9A). With the exception of the differences shown in FIG. 9A and the differences described below, any of the alternative implementations discussed above with respect to the scenario 800A (e.g., for messaging and processing) may apply to the scenario 900A.

The MN 104 can enable the MCG fast recovery function for the UE 102 by transmitting 914A an RRC reconfiguration message enabling an MCG fast recovery function. Alternatively, the UE 102 and the MN 104 can enable the MCG fast recovery function by default without the RRC reconfiguration procedure represented by events 914A and 916A. After detecting 904A an MCG failure, the UE 102 determines 906A whether a packet-based call (e.g., an IMS voice or video call) is ongoing at the UE 102. If there is no packet-based call, the UE 102 can perform 950A an MCG failure information procedure in response to the determination 904A. Then the UE can perform 928A an MCG failure recovery procedure with the MN 104. While not depicted in FIG. 9A, the MN 104 can perform a bearer configuration procedure, similar to the bearer configuration procedure 355A, 355B, 355C, and 355D, prior to performing 928A the MCG failure recovery procedure with the UE 102, similar to FIG. 8A. If there is a packet-based call, the UE 102 can perform 960A an RRC re-establishment procedure with a target MN (e.g., the MN 104, the SN 106A, base station 106B) instead of the MCG failure reporting procedure in response to the determination 904A, even though the UE 102 enabled the MCG fast recovery function. The target MN can perform 970A an RRC reconfiguration procedure with the UE 102 while or after performing the RRC re-establishment procedure.

Referring next to FIG. 9B, the base station 104 in scenario 900B operates as an MN, and the base station 106A operates as an SN. As mentioned above, events in the scenario 900B similar to those discussed above with respect to the scenarios 800B and 900A are labeled with similar reference numbers (e.g., with event 902A of FIG. 9A corresponding to event 902B of FIG. 9B). With the exception of the differences shown in FIG. 9B and the differences described below, any of the alternative implementations discussed above with respect to the scenario 900A (e.g., for messaging and processing) may apply to the scenario 900B.

The MN 104 can enable the MCG fast recovery function for the UE 102 by transmitting 914B an RRC reconfiguration message enabling an MCG fast recovery function with a recovery timer value, similar to event 914A. Alternatively, the UE 102 and the MN 104 can enable the MCG fast recovery function by default without the RRC reconfiguration procedure represented by 914B and 916B. In this alternative, the UE 102 can use a default recovery timer value. After the UE 102 determines 907B whether the (default) recovery timer value is larger than a threshold value. The UE 102 can determine the threshold value. In some implementations, the UE 102 can set the threshold value to a larger value if the UE 102 does not have a packet-based call and set the threshold value to a smaller value if the UE 102 has a packet-based call. The larger and the smaller values can belong to a certain set of predetermined values, for example, {T₁, T₂}. In other implementations, the UE 102 can set the threshold value irrespective of whether the UE 102 has a packet-based call.

If the (default) recovery timer value is smaller than or equal to the threshold value, the UE 102 can perform 950B an MCG failure information procedure in response to the determination 904B. Then the UE can perform 928B an MCG failure recovery procedure with the MN 104. While not depicted in FIG. 9B, the MN 104 can perform a bearer configuration procedure, similar to the bearer configuration procedure 355A, 355B, 355C, and 355D, prior to performing 928B the MCG failure recovery procedure with the UE 102, similar to FIG. 8A. If the (default) recovery timer value is larger than the threshold value, the UE 102 can perform 960B an RRC re-establishment procedure with a target MN (e.g., the MN 104, the SN 106A, or base station 106B) instead of the MCG failure reporting procedure in response to the determination 904B, even though the UE 102 enabled the MCG fast recovery function. The target MN can perform 970B an RRC reconfiguration procedure with the UE 102 while or after performing the RRC re-establishment procedure.

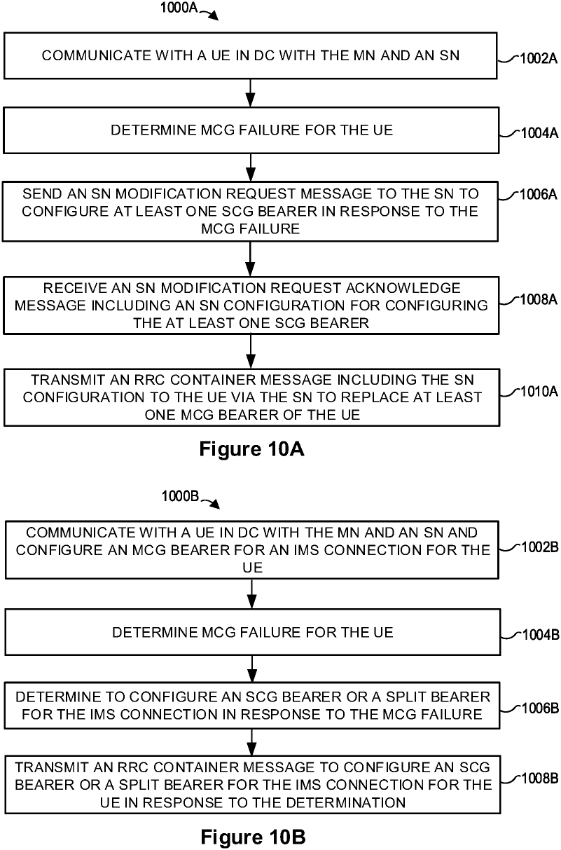

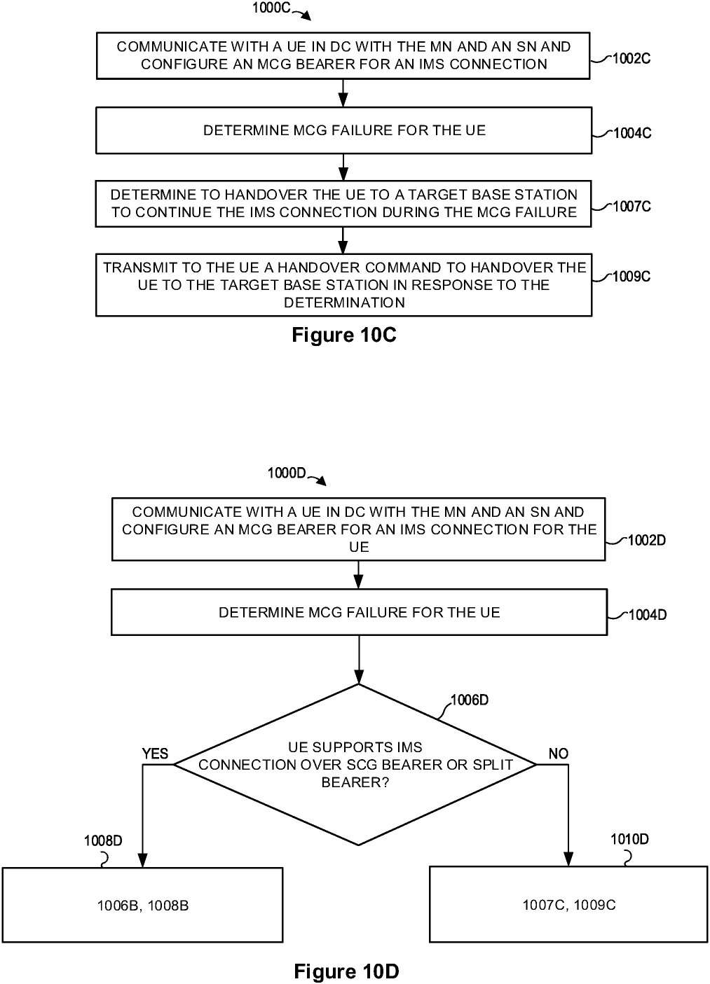

Next, several example methods a RAN including an MN and an SN (e.g., the RAN 105 including the MN 104 and the SN 106A), or a UE (e.g., the UE 102) can implement to manage connections with an IMS network (e.g., including an IMS signaling connection and/or an IMS service such as a voice call) during an MCG failure for the UE, are discussed with reference to FIG. 10A-16.

Referring first to FIG. 10A, an example method 1000A for managing a connection to a network entity that supports packet-based calls (e.g., a connection for IMS signaling or for data for an IMS service) for a UE (e.g., the UE 102) can be implemented in a base station of FIG. 1A, which may operate as an MN. The method 1000A begins at block 1002A, where the MN communicates with the UE in DC with the MN and an SN (e.g., event 302). The MN at block 1004A determines that an MCG failure occurred for the UE (e.g., event 308). Then the MN at block 1006A sends an SN Modification Request message to the SN to configure at least one SCG bearer in response to the MCG failure (e.g., event 312). The MN at block 1008A receives an SN Modification Request Acknowledge message including an SN configuration for configuring the at least one SCG bearer in response to the SN Modification Request message (e.g., event 314). The MN at block 1010A transmits an RRC container message including the SN configuration to the UE via the SN to replace at least one MCG bearer of the UE (e.g., events 316, 318).

FIG. 10B is a flow diagram of an example method 1000B, where an MN communicates with a UE is in DC with the MN and an SN and configure an MCG bearer for an IMS connection (e.g., for IMS signaling or for an IMS service) for the UE (e.g., event 302, 402). The MN at block 1004B determines whether an MCG failure occurred for the UE (e.g., event 308, 408). Then the MN at block 1006A determines to configure an SCG bearer or a split bearer for the IMS connection in response to the MCG failure (e.g., event 310, 410). The MN at block 1008B transmits an RRC container message to configure an SCG bearer or a split bearer for the IMS connection to the UE in response to the determination (e.g., events 316-318, 416-418).

FIG. 10C is a flow diagram of an example method 1000C for an MN. Blocks 1002C and 1004C are the same as blocks 1002B and 1004B respectively. The MN at block 1006C sends determines to handover the UE to a target base station to continue the IMS connection during the MCG failure. The MN at block 1009C transmits to the UE a handover command to handover the UE to the target base station in response to the determination (e.g., events 516-518, 616-618, 716-718). The target base station can be the MN, the SN, or a base station other than the MN and SN.

FIG. 10D is a flow diagram of an example method 1000D for an MN. Blocks 1002D and 1004D are the same as blocks 1002B and 1004B respectively. The MN at block 1006D determines whether the UE supports an IMS connection (e.g., for IMS signaling or for an IMS service) over an SCG bearer or split bearer. If the MN determines that the UE supports the IMS connection over an SCG or split bearer, the MN at block 1008D performs blocks 1006B and 1008B as described in FIG. 10B. If the MN determines that the UE does not support the IMS connection over an SCG or split bearer, the MN at block 1010D performs blocks 1007C and 1009C as described in FIG. 10B.

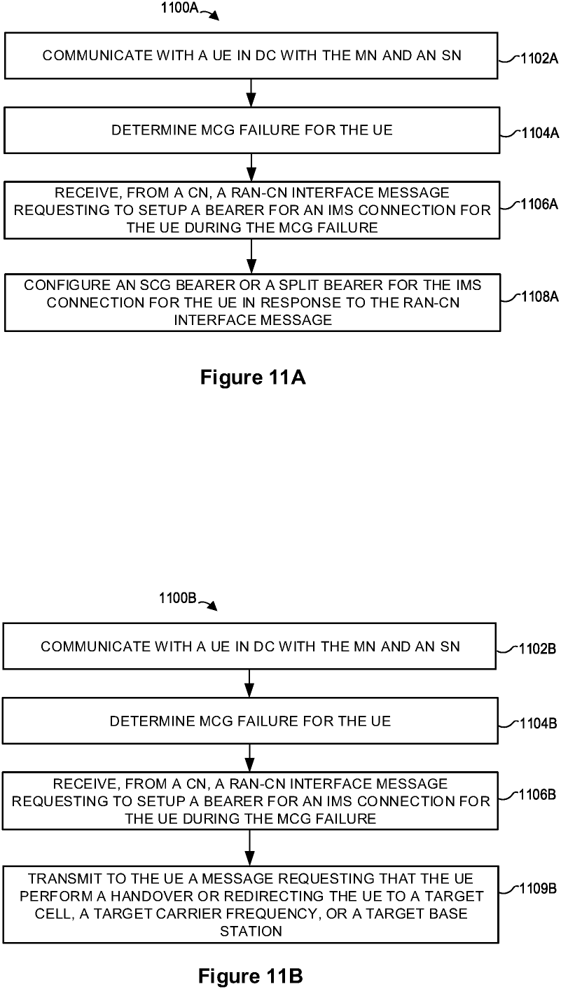

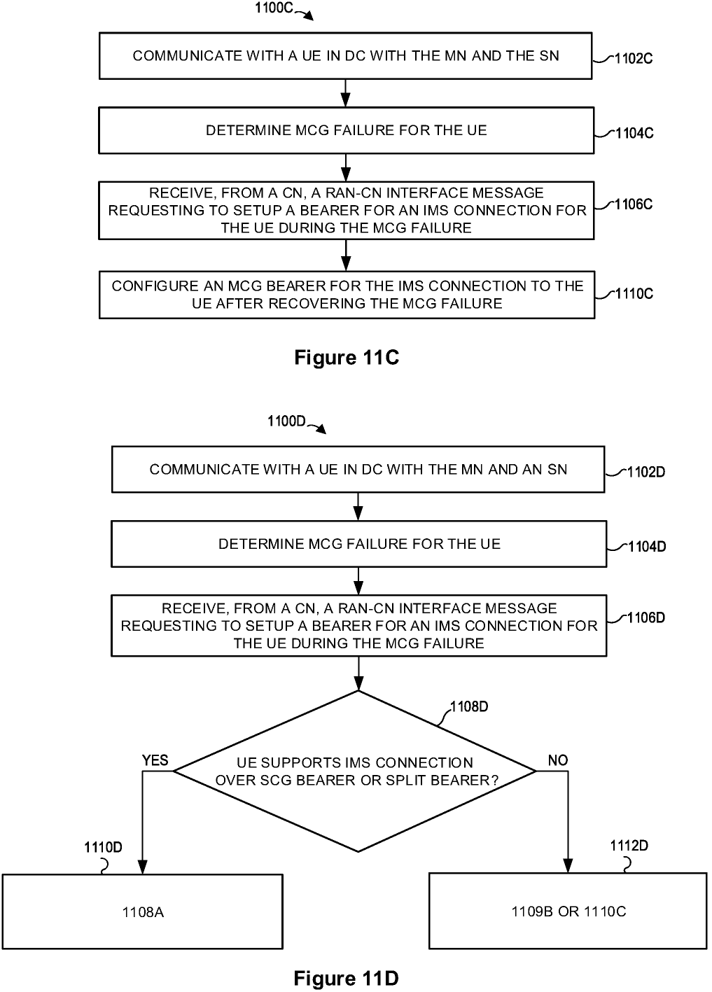

FIG. 11A is a flow diagram of an example method 1100A for an MN. Blocks 1102A and 1104A are the same as blocks 1002A and 1004A respectively. The MN at block 1106A receives, from a CN, a RAN-CN interface message requesting that the MN set up a bearer for an IMS connection for the UE during the MCG failure. The MN at block 1108A configures an SCG bearer or a split bearer for the IMS connection for the UE in response to the RAN-CN interface message (e.g., event 355, 457).

FIG. 11B is a flow diagram of an example method 1100B for an MN. Blocks 1102B, 1104B and 1106B are the same as blocks 1002A, 1004A and 1106A respectively. The MN at block 1109B transmits to the UE a message requesting that the UE perform a handover or redirecting the UE to a target cell, a target carrier frequency or a target base station in response to the RAN-CN interface message (e.g., events 516-518, 616-618, 716-718). The target base station can be the MN, the SN, or a base station other than the MN and SN.

FIG. 11C is a flow diagram of an example method 1100C for an MN. Blocks 1102C, 1104C and 1106C are the same as blocks 1002A, 1004A and 1106A respectively. The MN at block 1110C configures an MCG bearer for the IMS connection for the UE after recovering the MCG failure. In some implementations, the MN refrains from sending a RAN-CN interface response message to the CN to indicate failure to set up a bearer for the IMS connection during the MCG failure (e.g., within a time duration after determining the MCG failure). The MN can send the RAN-CN interface response message if the MN cannot recover the MCG failure within the time duration.

FIG. 11D is a flow diagram of an example method 1100D for an MN. Blocks 1102D, 1104D and 1106D are the same as blocks 1002A, 1004A and 1106A respectively. The MN at block 1108D determines whether the UE supports IMS connection over an SCG bearer or split bearer. If the MN determines the UE supports IMS connection over an SCG or split bearer, the MN at block 1110D performs block 1108A as described in FIG. 11A. If the MN determines the UE does not support IMS connection over an SCG or split bearer, the MN at block 1112D performs block 1109B or 1110C as described in FIGS. 11B and 11C respectively.

Alternatively, if the MN determines the UE does not support IMS connection over an SCG or split bearer, the MN at block 1112D can send a RAN-CN interface response message to the CN indicating unsuccessful establishment of a bearer (or a QoS flow) in response to the RAN-CN interface message, instead of performing block 1109B or 1110C. In some implementations, the MN can include, in the RAN-CN interface response message, a cause value indicating radio connection with the UE lost or MCG failure. The RAN-CN interface response message can be a PDU SESSION RESOURCE MODIFY RESPONSE message.

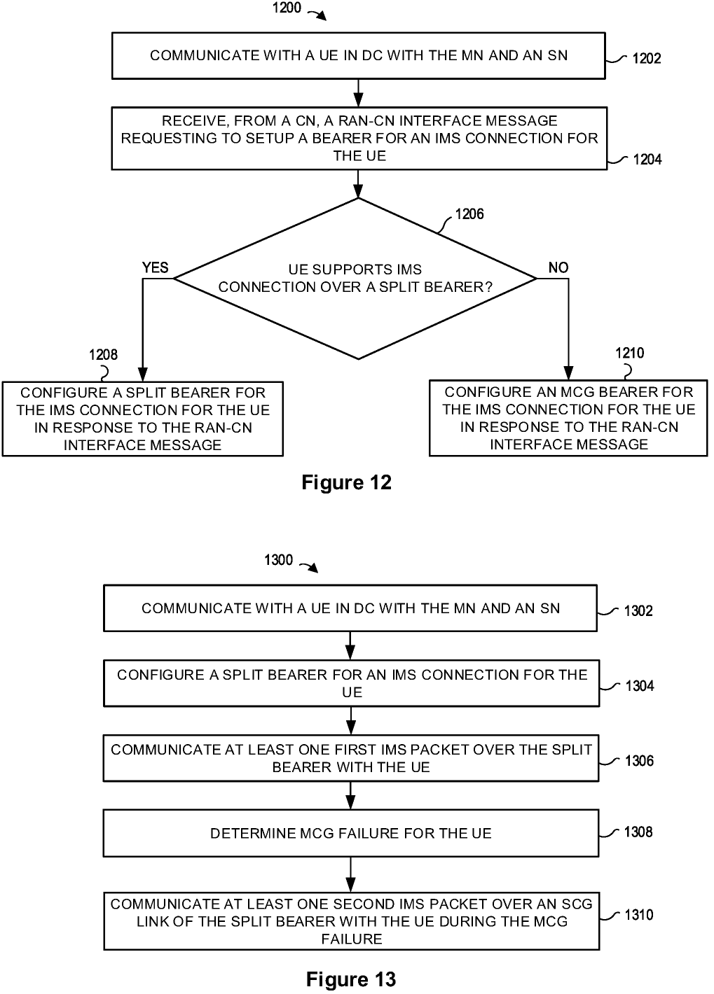

FIG. 12 is a flow diagram of an example method 1200, where the MN communicates with the UE in DC with the MN and an SN (e.g., event 302). The MN at block 1204 receives, from a CN, a RAN-CN interface message requesting that the MN set up a bearer for an IMS connection for the UE during the MCG failure. The MN at block 1206 determines whether the UE supports an IMS connection (e.g., for IMS signaling or for an IMS service) over a split bearer. If the MN determines that the UE supports the IMS connection over a split bearer, the MN at block 1208 configures a split bearer for the IMS connection for the UE in response to the RAN-CN interface message (e.g., event 342C, 342D, 442C, 442D). If the MN determines that the UE does not support IMS connection over a split bearer, the MN at block 1210 configures an MCG bearer for the IMS connection for the UE in response to the RAN-CN interface message (e.g., event 302A, 302B, 402A, 402B).

Now referring to FIG. 13, an example method 1300 for managing an IMS connection during MCG failure can be implemented in a base station of FIG. 1A operated as an MN for example. The method 1300 begins at block 1302, where the MN communicates with a UE in DC with the MN and an SN (e.g., event 342, 442). The MN 104 at block 1304 configures a split bearer for an IMS connection for the UE (e.g., event 342, 442). The MN 104 at block 1306 communicates (e.g., transmits and/or receives) at least one first IMS packet over the split bearer with the UE (e.g., event 342, 442). The MN 104 at block 1308 determines that an MCG failure occurred for the UE (e.g., event 308, 408). Then the MN 104 at block 1310 communicates at least one second IMS packet over an SCG link of the split bearer with the UE during the MCG failure (e.g., event 327, 427).

In some implementations, the MN 104 may communicate the at least one first IMS packet over an MCG link of the split bearer with the UE while no MCG failure is occurring for the UE. More specifically, the MN 104 in these implementations may only communicate the at least one first IMS packet over an MCG link of the split bearer with the UE.

In some implementations, an SN (e.g., a base station 106A operating as an SN) can implement a method similar to method 1300. Similar to blocks 1302, 1304, and 1306, respectively, the SN communicates with a UE in DC with an MN and the SN, configures a split bearer for an IMS connection for the UE, and communicates at least one first IMS packet over the split bearer with the UE (e.g., event 342, 442). If the UE detects an MCG failure, then the SN may, similar to block 1310, communicate at least one second IMS packet over an SCG link of the split bearer with the UE during the MCG failure (e.g., event 327, 427).

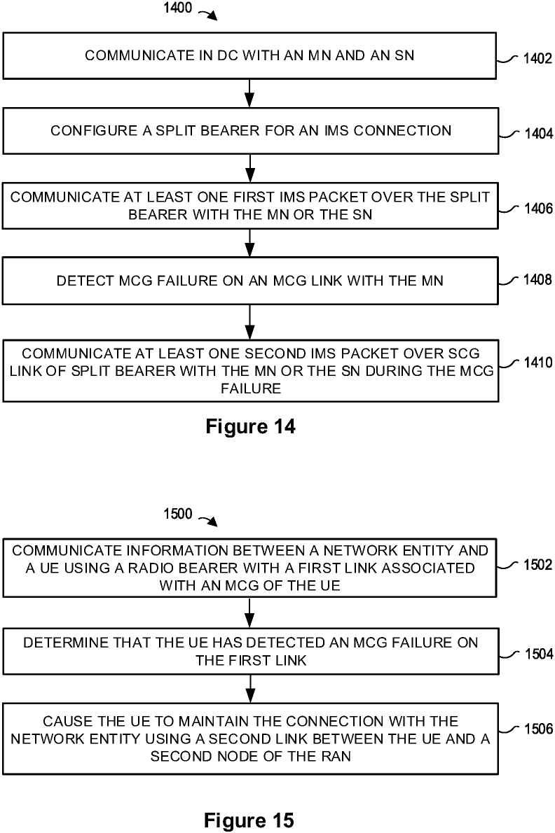

Referring next to FIG. 14, an example method 1400 for managing an IMS connection during MCG failure can be implemented in a UE, such as the UE 102 of FIG. 1A. The method 1400 begins at block 1402, where the UE in DC communicates with an MN and an SN (e.g., event 342, 442). The UE at block 1404 configures a split bearer for an IMS connection for the UE (e.g., event 342, 442). The UE at block 1406 communicates (e.g., transmits and/or receives) at least one first IMS packet over the split bearer with the MN or SN (e.g., event 342, 442). The UE at block 1408 detects an MCG failure for the UE (e.g., event 308, 408). Then the UE at block 1410 communities at least one second IMS packet over an SCG link of the split bearer with the MN or SN during the MCG failure (e.g., event 327, 427).

In some implementations, the UE may communicate the at least one first IMS packet over an MCG link of the split bearer with the MN or SN while no MCG failure is occurring for the UE. More specifically, the UE in these implementations may only communicate the at least one first IMS packet over an MCG link of the split bearer with the MN or SN.

FIG. 15 is a flow diagram for an example method 1500 for managing a connection between a network entity (e.g., a network entity of the IMS network 170) that supports packet-based calls (e.g., IMS services such as voice and video calls) and a UE (e.g., the UE 102) in DC with an MN and an SN. In some implementations, the MN and the SN can be the base stations 104 and 106A, respectively. In other implementations, the MN and the SN can be implemented in a single base station such as the base station 106A, where the CU 172 and the M-DU 174A operate as the MN, and the CU 172 and the S-DU 174B operate as the SN. The method 1500 may be implemented by a first node of a RAN (e.g., the RAN 105), such as the MN 104 or the CU 172 of the MN.

At block 1502, the first node communicates, by processing hardware, information between the network entity and the UE using a radio bearer with a first link associated with an MCG of the UE (e.g., events 302, 342, 402, 442, 502, 602, 702, 802, 902). The radio bearer, for example, can be an MCG radio bearer or an MCG link of a split bearer. The information can be signaling information (e.g., the first link may be dedicated to conveying signaling information and the connection may include an IMS signaling connection), or the information can be data (e.g., the first link may be dedicated to conveying data and the connection may include a connection for an IMS service such as a video or voice call). In some scenarios, communicating the information may include communicating information via a second radio bearer. For example, a first radio bearer may be dedicated to conveying signaling and a second radio bearer may be dedicated to conveying data.

At block 1504. the first node determines, by processing hardware, that the UE has detected an MCG failure on the first link (e.g., based on event 308, 408, 508, 608, 708, or as a result of MCG failure reporting procedure 350, 850, or 950). At block 1506, the first node causes the UE to maintain the connection with the network entity using a second link between the UE and a second node of the RAN (e.g., bearer configuration procedure 355 and 326; 342 and 327; bearer configuration procedure 457 and 426; 442 and 427; handover preparation and handover in events 512-526, 613-626, or 732-738, 716-726; bearer configuration procedure 855). The second link can be an SCG bearer, an SCG link of a split bearer, or a link to the SN or another base station after handover. Similarly, the second node can be the SN, a DU of the SN, or another base station different from the MN or the SN.

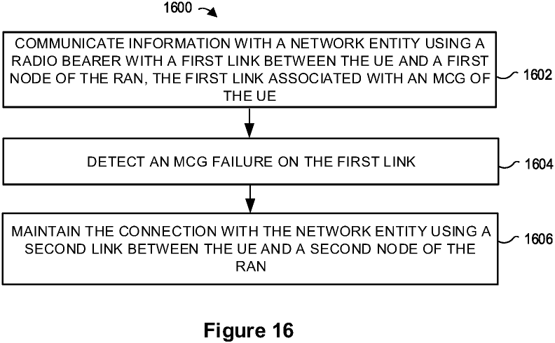

FIG. 16 is a flow diagram for an example method 1600 for managing a connection with a network entity (e.g., a network entity of the IMS network 170) that supports packet-based calls (e.g., IMS services such as voice and video calls) via the RAN. The method 1600 may be implemented by a UE (e.g., the UE 102) in DC with an MN and an SN of a RAN (e.g., the RAN 105). In some implementations, the MN and the SN can be the base stations 104 and 106A, respectively. In other implementations, the MN and the SN can be implemented in a single base station such as the base station 106A, where the CU 172 and the M-DU 174A operate as the MN, and the CU 172 and the S-DU 174B operate as the SN.

At block 1602, the UE communicates, by processing hardware, information between the network entity using a radio bearer with a first link between the UE and a first node of the RAN, the first link associated with an MCG of the UE (e.g., events 302, 342, 402, 442, 502, 602, 702, 802, 902). Similar to method 1500, the first node can be, for example, the MN 104 or the CU 172 of the MN. The radio bearer, for example, can be an MCG radio bearer or an MCG link of a split bearer. The information can be signaling information (e.g., the first link may be dedicated to conveying signaling information and the connection may include an IMS signaling connection), or the information can be data (e.g., the first link may be dedicated to conveying data and the connection may include a connection for an IMS service such as a video or voice call). In some scenarios, communicating the information may include communicating information via a second radio bearer. For example, a first radio bearer may be dedicated to conveying signaling and a second radio bearer may be dedicated to conveying data.

At block 1604, the UE detects, by the processing hardware, an MCG failure for the first link (e.g., events 304, 404, 504, 604, 704, 804, 904). At block 1606, the UE maintains, by the processing hardware, the connection with the network entity using a second link between the UE and a second node of the RAN (e.g., events 326, 327, 426, 427, 626, 726). The second link can be an SCG bearer, an SCG link of a split bearer, or a link to the SN or another base station after handover. Similarly, the second node can be the SN, a DU of the SN, or another base station different from the MN or the SN.

The following list of examples reflects a variety of the embodiments explicitly contemplated by the present disclosure:

Example 1. A method in a first node of a radio access network (RAN), for managing a connection between a network entity that supports packet-based calls and a user equipment (UE) in dual connectivity with a master node (MN) and a secondary node (SN), the method comprising: communicating, by processing hardware, information between the network entity and the UE, using a radio bearer with a first link associated with a master cell group (MCG) of the UE; determining, by the processing hardware, that the UE has detected an MCG failure on the first link; and causing, by the processing hardware, the UE to maintain the connection with the network entity using a second link between the UE and a second node of the RAN.

Example 2. The method of example 1, wherein: the radio bearer is an MCG bearer; and the second link is associated with a secondary cell group (SCG) bearer.

Example 3. The method of example 2 implemented in the MN, wherein causing the UE to maintain the connection includes: in response to the determining, sending a request to the SN to configure the SCG bearer.

Example 4. The method of example 2 implemented in a central unit (CU) of a distributed base station, wherein causing the UE to maintain the connection includes: in response to the determining, sending a request to a distributed unit (DU) of the distributed base station supporting an SCG to configure the SCG bearer.

Example 5. The method of example 1, wherein: the radio bearer is a split bearer; and the second link is associated with a secondary cell group (SCG) link of the split bearer.

Example 6. The method of example 5, wherein causing the UE to maintain the connection includes configuring the UE to use the second link for the connection, prior to determining that the UE has detected the MCG failure.

Example 7. The method of example 5 or 6 implemented in a CU of a distributed base station, wherein: the split bearer terminates at the UE and a first DU of the distributed base station, the first DU supporting an SCG of the UE, and routes information through a second DU supporting the MCG.

Example 8. The method of any of the preceding examples, wherein: the radio bearer is a first radio bearer dedicated to conveying signaling; and causing the UE to maintain the connection further includes: causing the UE to use a third link between the UE and the RAN, the third link dedicated to conveying data.

Example 9. The method of any of the preceding examples, wherein: the radio bearer is a first radio bearer dedicated to conveying signaling; communicating the information further includes communicating data between the network entity and the UE, using a second radio bearer with a third link associated with the MCG; and causing the UE to maintain the connection further includes causing the UE to use a fourth link between the UE and the RAN, the fourth link dedicated to conveying data and the second link dedicated to conveying signaling.

Example 10. The method of example 1, wherein causing the UE to maintain the connection includes: causing the UE to hand over to the second node.

Example 11. The method of example 10, wherein: the first node implements the MN; and the second node implements the SN.

Example 12. The method of example 10 implemented in a CU of a distributed base station, wherein: a first DU of the distributed base station supports the MCG; and the second node operates as the SN in a second DU of the distributed base station.

Example 13. The method of example 10, wherein: the first node implements the MN; and the second node operates as a target MN.

Example 14.The method of example 1, wherein: the first link is associated with a first radio access technology (RAT); and the second link is associated with a second RAT different from the first RAT.

Example 15. The method of example 1, further comprising: determining, by the processing hardware and prior to determining that the UE has detected the MCG failure, whether an MCG recovery procedure should be enabled for the UE; wherein causing the UE to maintain the connection is in response to determining that the MCG recovery procedure has been enabled for the UE.

Example 16. The method of example 15, wherein determining whether the MCG recovery procedure should be enabled for the UE is based on determining whether the UE has a packet-based call in progress.

Example 17. The method of example 16, further comprising determining a timer length for the MCG recovery procedure based on determining whether the UE has a packet-based call in progress.

Example 18. A node of a radio access network (RAN) comprising processing hardware and configured to implement a method according to any one of the preceding examples.

Example 19. A method in a user equipment (UE) in dual connectivity with a master node (MN) and a secondary node (SN) of a radio access network (RAN) for managing a connection with a network entity that supports packet-based calls via the RAN, the method comprising: communicating, by processing hardware, information with the network entity using a radio bearer with a first link between the UE and a first node of the RAN, the first link associated with a master cell group (MCG) of the UE; detecting, by the processing hardware, an MCG failure on the first link; maintaining, by the processing hardware, the connection with the network entity using a second link between the UE and a second node of the RAN.

Example 20. The method of example 19, wherein: the radio bearer is an MCG bearer; and the second link is associated with a secondary cell group (SCG) bearer.

Example 21. The method of example 20, wherein the first node is the MN, and wherein the method further comprises: receiving, by the processing hardware from the SN, a configuration for the second link, wherein the UE maintains the connection with the network entity in accordance with the configuration.

Example 22. The method of example 20, wherein the first node is a central unit (CU) of a distributed base station, and wherein the method further comprises: receiving, by the processing hardware from a distributed unit (DU) of the distributed base station, the DU supporting an SCG, a configuration for the second link, wherein the UE maintains the connection with the network entity in accordance with the configuration.

Example 23. The method of example 19, wherein: the radio bearer is a split bearer; and the second link is associated with a secondary cell group (SCG) link of the split bearer.

Example 24. The method of example 23, wherein maintaining the connection includes using the second link in accordance with a configuration received prior to detecting the MCG failure.

Example 25. The method of example 23, further comprising: receiving, by the processing hardware from the SN, a configuration for the second link, wherein the UE maintains the connection with the network entity in accordance with the configuration.

Example 26. The method of any one of examples 23-25, wherein the first node is a CU of a distributed base station, and wherein the split bearer terminates at the UE, a first DU of the distributed base station, and routes information through a second DU of the distributed base station.

Example 27. The method of any one of examples 19-26, wherein: the radio bearer is a first radio bearer dedicated to conveying signaling; and maintaining the connection further includes: using a third link between the UE and the RAN, the third link dedicated to conveying data.

Example 28. The method of any one of examples 19-26, wherein: the radio bearer is a first radio bearer dedicated to conveying signaling; communicating the information further includes communicating data with the network entity, using a second radio bearer with a third link associated with the MCG; and maintaining the connection includes using a fourth link between the UE and the RAN, the fourth link dedicated to conveying data and the second link dedicated to conveying signaling.

Example 29. The method of example 19, wherein maintain the connection includes: performing a handover with the second node.

Example 30. The method of example 29, wherein: the first node implements the MN; and the second node implements the SN.

Example 31. The method of example 29, wherein: the first node is a CU of a distributed base station; a first DU of the distributed base station supports the MCG; and the second node operates as the SN in a second DU of the distributed base station.

Example 32. The method of example 29, wherein: the first node implements the MN; and the second node operates as a target MN.

Example 33. The method of example 19, wherein: the first link is associated with a first radio access technology (RAT); and the second link is associated with a second RAT different from the first RAT.

Example 34. The method of example 19, further comprising: receiving, by the processing hardware from the first node, a request to enable an MCG recovery procedure; and enabling, by the processing hardware, the MCG recovery procedure at the UE; wherein maintaining the connection is in response to determining that the MCG recovery procedure is enabled.

Example 35. The method of example 34, wherein receiving the request includes receiving the request while the UE has a packet-based call in progress.

Example 36. The method of example 34, wherein maintaining the connection is further in response to determining that the UE has a packet-based call in progress.

Example 37. The method of example 34, wherein maintaining the connection is further in response to determining that a timer for the MCG recovery procedure is smaller than a threshold time period.

Example 38. A user equipment (UE) comprising processing hardware and configured to implement a method according to any one of examples 19-37.

The following additional considerations apply to the foregoing discussion.

The “QoS flow” described above can be replaced by “EPS radio access bearer” in the case of EN-DC.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC), a digital signal processor (DSP)) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for managing communication between a UE and a RAN during MCG failure through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

What is claimed is:

1. A method in a first node of a radio access network (RAN), for managing a connection between a network entity that supports packet-based calls and a user equipment (UE) in dual connectivity with a master node (MN) and a secondary node (SN), the method comprising:
communicating, by the first node, information between the network entity and the UE, using a first radio bearer associated with a master cell group (MCG) for the UE;
determining, by the first node, that the UE has detected an MCG failure;
in response to the determining, sending, by the first node, to a second node of the RAN supporting a secondary cell group (SCG) for the UE, a request to configure a second radio bearer associated with the SCG to maintain the connection between the UE and the network entity using the second radio bearer; and
performing, by the first node, an MCG recovery procedure.

2. The method of claim 1 implemented in the MN, wherein the second node is the SN.

3. The method of claim 1 implemented in a central unit (CU) of a distributed base station, wherein the second node is a distributed unit (DU) of the distributed base station.

4. The method of claim 1, wherein:
the first radio bearer is dedicated to conveying signaling.

5. The method of claim 4, wherein:
communicating the information further includes communicating data between the network entity and the UE, using a third radio bearer associated with the MCG,
wherein the request further indicates to the second node to configure a fourth radio bearer associated with the SCG, the fourth radio bearer dedicated to conveying data and the second radio bearer dedicated to conveying signaling.

6. The method of claim 1, wherein:
the first radio bearer is associated with a first radio access technology (RAT); and
the second radio bearer is associated with a second RAT different from the first RAT.

7. The method of claim 1, further comprising:
determining, by the processing hardware and prior to determining that the UE has detected the MCG failure, whether the MCG recovery procedure should be enabled for the UE;
wherein sending the request is further in response to determining that the MCG recovery procedure has been enabled for the UE.

8. The method of claim 7, wherein determining whether the MCG recovery procedure should be enabled for the UE is based on determining whether the UE has a packet-based call in progress.

9. The method of claim 7, further comprising determining a timer length for the MCG recovery procedure based on determining whether the UE has a packet-based call in progress.

10. A node of a radio access network (RAN) configured to manage a connection between a network entity that supports packet-based calls and a user equipment (UE) in dual connectivity with a master node (MN) and a secondary node (SN), the node comprising processing hardware and configured to :
communicate information between the network entity and the UE, using a first radio bearer associated with a master cell group (MCG) for the UE;
determining that the UE has detected an MCG failure;
in response to the determining, send, to a second node of the RAN supporting a secondary cell group (SCG) for the UE, a request to configure a second radio bearer associated with the SCG to maintain the connection between the UE and the network entity using the second radio bearer; and
perform an MCG recovery procedure.

11. A method in a user equipment (UE) in dual connectivity with a master node (MN) and a secondary node (SN) of a radio access network (RAN) for managing a connection with a network entity that supports packet-based calls via the RAN, the method comprising:
communicating, by processing hardware, information with the network entity using a first radio bearer between the UE and a first node of the RAN, the first radio bearer associated with a master cell group (MCG) for the UE;
detecting, by the processing hardware, an MCG failure on the first radio bearer;
reporting, by the processing hardware, the MCG failure to a second node of the RAN supporting a secondary cell group (SCG) for the UE;
after reporting the MCG failure, receiving, by the processing hardware from the second node, a configuration for a second radio bearer associated with the SCG;
maintaining, by the processing hardware, the connection with the network entity using the second radio bearer in accordance with the configuration; and
performing, by the UE, an MCG recovery procedure.

12. The method of claim 11, wherein:
the first node is the MN, and the second node is the SN; or
the first node is a central unit (CU) of a distributed base station, and the second node is a distributed unit (DU) of the distributed base station, the DU supporting the SCG.

13. The method of claim 11, wherein:
the first radio bearer is dedicated to conveying signaling; and
maintaining the connection further includes:
using a third radio bearer associated with the SCG, the third radio bearer dedicated to conveying data.

14. The method of claim 11, wherein:
the first radio bearer is dedicated to conveying signaling;
communicating the information further includes communicating data with the network entity, using a third radio bearer associated with the MCG; and
maintaining the connection includes using a fourth radio bearer associated with the SCG, the fourth radio bearer dedicated to conveying data and the second radio bearer dedicated to conveying signaling.

15. (canceled)

16. The node of claim 10 implemented in the MN, wherein the second node is the SN.

17. The node of claim 10 implemented in a central unit (CU) of a distributed base station, wherein the second node is a distributed unit (DU) of the distributed base station.

18. The node of claim 10, wherein:
the first radio bearer is dedicated to conveying signaling.

19. The node of claim 10, wherein:
communicating the information further includes communicating data between the network entity and the UE, using a third radio bearer associated with the MCG,
wherein the request further indicates to the second node to configure a fourth radio bearer associated with the SCG, the fourth radio bearer dedicated to conveying data and the second radio bearer dedicated to conveying signaling.

20. The node of claim 10, wherein:
the first radio bearer is associated with a first radio access technology (RAT); and
the second radio bearer is associated with a second RAT different from the first RAT.
